(19) United States
(12) Patent Application Publication
(10) Pub. No.: US 2025/0328545 A1
(43) Pub. Date: Oct. 23, 2025

(54) ZERO-COPY CLONE OF DYNAMIC TABLES

(71) Applicant: Snowflake Inc., Bozeman, MT (US)

(72) Inventors: Arvid Heise, Michendorf (DE); Sasha Yan Lionheart, Seattle, WA (US); Daniel Mills, Seattle, WA (US); Leon Papke, Berlin (DE); Daniel E. Sotolongo, Seattle, WA (US); Attila-Péter Tóth, Bellevue, WA (US); Lanhao Wu, Seattle, WA (US)

(21) Appl. No.: 19/025,658

(22) Filed: Jan. 16, 2025

Related U.S. Application Data
(60) Provisional application No. 63/636,235, filed on Apr. 19, 2024.

(51) Int. Cl. G06F 16/27; G06F 16/22

(52) U.S. Cl. CPC G06F 16/27; G06F 16/2282

(57) ABSTRACT

Provided herein are systems and methods for a zero-copy clone of a DT. A method includes performing a clone operation on a dynamic table (DT) to generate a cloned DT. The DT is based on a query applied on a base table. The cloned DT is based on the query applied on a cloned base table corresponding to the base table. A first delta is determined based on at least one change in the base table between a first version of the base table used by the DT at a time of the clone operation and a second version of the base table generated prior to the clone operation. A first refresh operation of the cloned DT is performed based on the first delta.

### PRIORITY CLAIM

This application claims the benefit of priority to the U.S. Provisional Patent Application 63/636,235, filed Apr. 19, 2024, and entitled “ZERO-COPY CLONE OF DYNAMIC TABLES,” which application is incorporated herein by reference in its entirety.

### TECHNICAL FIELD

Embodiments of the disclosure relate generally to databases and, more specifically, to a database object type (e.g., a dynamic table or DT) and zero-copy clone of DTs.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used to store different types of content, such as bibliographic, full text, numeric, and image content. Further, in computing, different database systems may be classified according to the organizational approach of the database. There are many different types of databases, including relational databases, distributed databases, cloud databases, object-oriented databases, and others.

Various entities and companies use databases to store information that may need to be accessed or analyzed. When a query is generated to extract certain organized information from the database, a query statement is executed against the database data. The query returns specific data according to one or more query predicates that indicate what information should be returned by the query. The query extracts specific data from the database and formats that data into a readable form. The query may be written in a language that is understood by the database, such as Structured Query Language (“SQL”), so the database systems can determine what data should be located and how it should be returned. The query may request any pertinent information that is stored within the database. If the appropriate data can be found to respond to the query, the database has the potential to reveal complex trends and activities. This power can be harnessed through the use of a successfully executed query. However, the configuration of queries and consuming changes to queries may be challenging and time-consuming.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a block diagram illustrating the components of a compute service manager using a DT manager, in accordance with some embodiments of the present disclosure.

FIG. 3 is a block diagram illustrating components of an execution platform, in accordance with some embodiments of the present disclosure.

FIG. 4 is a diagram illustrating an example data enrichment pipeline using dynamic tables (DTs), in accordance with some embodiments of the present disclosure.

FIG. 5 is a diagram of a view graph of DTs associated with different lag targets, in accordance with some embodiments of the present disclosure.

FIG. 6 is a diagram of a task graph of DTs associated with scheduled refreshes at different times according to individual lag targets, in accordance with some embodiments of the present disclosure.

FIG. 7 is a diagram illustrating the use of data manipulation language (DML) commands and time travel queries to compute an updated set of a DT with respect to specific versions of its base relations, in accordance with some embodiments of the present disclosure.

FIG. 8 is a diagram of using a CHANGES clause in connection with query processing, in accordance with some embodiments of the present disclosure.

FIG. 9 is a diagram of a stream object configuration for a table, in accordance with some embodiments of the present disclosure.

FIG. 10 is a diagram of shared views, in accordance with some embodiments of the present disclosure.

FIG. 11 is a diagram of a stream object based on a complex view, in accordance with some embodiments of the present disclosure.

FIG. 12 is a diagram of a view evolution, in accordance with some embodiments of the present disclosure.

FIG. 13 is a diagram of a DT refresh, in accordance with some embodiments of the present disclosure.

FIG. 14 is a diagram illustrating the determination of changes (or delta (Δ)) to a base table for a DT refresh, in accordance with some embodiments of the present disclosure.

FIG. 15 is a diagram illustrating the creation of DT clones and corresponding metadata information, in accordance with some embodiments of the present disclosure.

FIG. 16 is a diagram illustrating the performing of refresh operations on cloned DTs, in accordance with some embodiments of the present disclosure.

FIG. 17 is a diagram illustrating the creation of cloned DTs based on different versions of a base table and corresponding metadata information for each clone, in accordance with some embodiments of the present disclosure.

FIG. 18 is a diagram illustrating the performing of a special refresh operation after cloning, in accordance with some embodiments of the present disclosure.

FIG. 19 is a flow diagram illustrating the operations of a database system in performing a method for cloning a dynamic table, in accordance with some embodiments of the present disclosure.

FIG. 20 is a flow diagram illustrating the operations of a database system in performing a method for cloning a dynamic table, in accordance with some embodiments of the present disclosure.

FIG. 21 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and the like. If stored internally in the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

As used herein, the term “clone” indicates a snapshot of a container and its contained objects. In some aspects, the snapshot time is the most recently committed version. However, by using the BEFORE or AT keywords, a user can specify the version to be cloned. In some aspects, when a clone of a table is generated, a new metadata record is generated, which contains compacted metadata of the table at the clone command's version. In this regard, a clone operation can be configured as a metadata-only operation and can, therefore, be referred to as zero-copy cloning.

As used herein, the term “view” indicates a named SELECT statement, conceptually similar to a table. In some aspects, a view can be secure, which prevents queries from getting information on the underlying data obliquely.

As used herein, the term “materialized view” indicates a view that is eagerly computed rather than lazily (e.g., as a standard view). In some aspects, efficient implementation of materialized views overlaps with change tracking functionality.

As used herein, the term “CHANGES clause” indicates a syntactic modifier on a FROM clause indicating that a SELECT statement should return the changes that occurred to the specified table between two given times. In some aspects, several different change types can be requested:
(a) The default type (also referred to as delta) finds the smallest set of changes that could account for the difference between the tables at the given times;
(b) The append-only type only finds rows that were appended to the table (with subsequent updates or deletions of the row not being recorded); and
(c) The audit type (currently not public) computes all changes made between the given times, even if they cancel out.

In some aspects, DTs can be used to improve functionalities provided by tasks and materialized views (MVs). As used herein, the term “dynamic table” (or DT) indicates data that is the result of a query, which can be periodically updated and queried. Tasks are powerful, but the conceptual model may limit their usability. Most use cases for tasks can be satisfied with tasks combined with stored procedures, streams, data manipulation language (DML), and transactions. Streams on views can be used to facilitate stateless incremental computations. Some drawbacks associated with tasks (which can be successfully addressed with DTs) include the following: (a) backfill workflows must be implemented and orchestrated manually, and (b) streams cannot cleanly increment stateful operators (e.g., GroupBy, outer joins, and windows). As used herein, the term “dynamic table” (or DT) is interchangeable with the term “materialized table” (or MT).

In some aspects, MVs can be used as query accelerators. Simple queries may be sufficient, and only aggregating operations are supported (e.g., no joins and no nested views are supported). Additionally, implementation costs may be insignificant, and less visibility and control may be exposed to users.

In some aspects, DTs can be used to target data engineering use cases. While MVs can support only aggregating operations (e.g., a single GroupBy on a single table), DTs remove query limitations and allow joining and nesting in addition to aggregation. Additional benefits of DTs include providing controls over cost and table refresh operations, automating common operations, including incrementalization and backfill, and providing a comprehensive operational experience.

Aspects of the present disclosure provide techniques for zero-copy cloning of database object types (e.g., DTs). If a DT is cloned as part of a container and the DT is not up to date when cloned, then the first refresh of the clone will be a reinitialization (which can be time-consuming and costly to perform). For example, suppose a dynamic table is cloned as part of a container clone, and the clone command is run with an AT TIME, where the dynamic table's base tables had unconsumed changes. In that case, the next refresh of the DT has to be a reinitialization (e.g., truncate and reload data). Reinitialization may also be needed because zero-copy clones create a single version of every cloned table; however, DTs rely on the table's history to identify changes that need to be applied to the DT during the incremental refresh process.

The disclosed zero-copy cloning techniques can be used to avoid full reinitialization of dynamic tables when the history from clone sources and cloned objects is available. Hence, the disclosed techniques can use an incremental refresh when the history of the table in the clone source is available. When a DT is up to date, the offsets can be mapped on the clone to match the cloned source's table versions. When a DT is not up to date, the offsets may not be mapped, and the next refresh will be a full refresh because the delta between the base tables' clone's previous version (empty table) and the current version is the whole table.

The disclosed techniques can be used to configure incremental refreshes that are orders of magnitude faster and cheaper to apply than reinitializing the dynamic table. The disclosed techniques can be used to clone DTs in a container so that the DT performs a similar amount of work in its next incremental refresh as the DT sources.

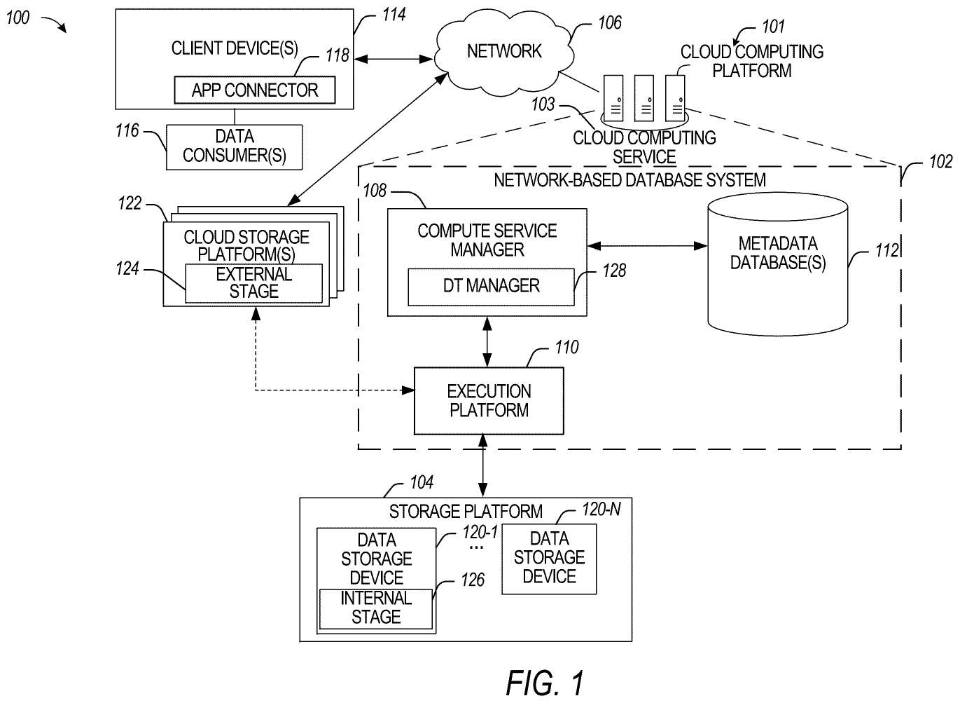

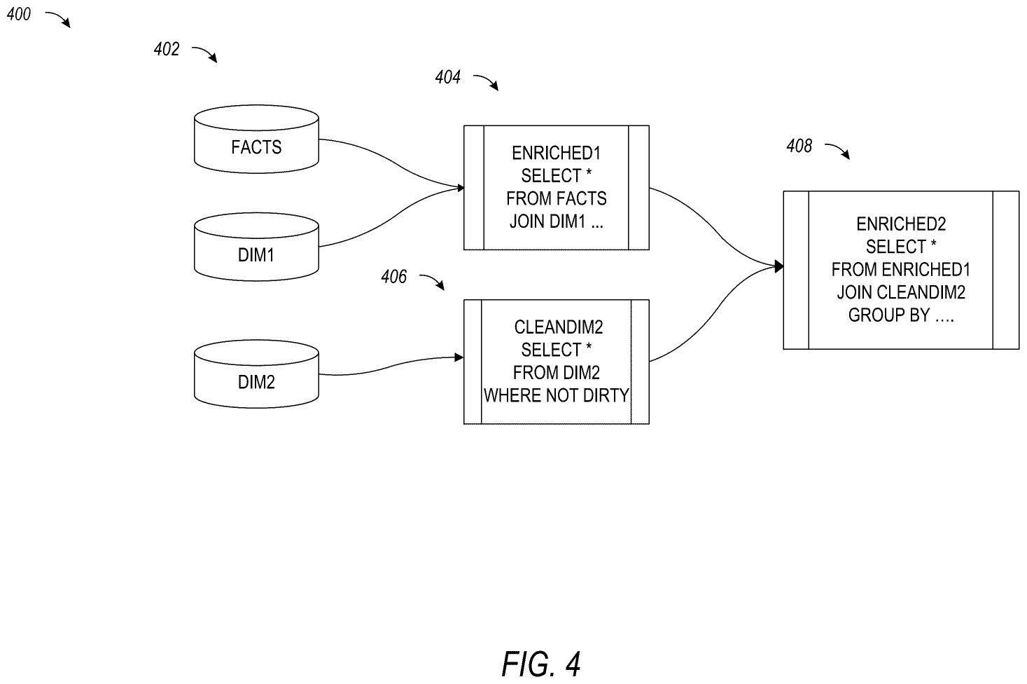

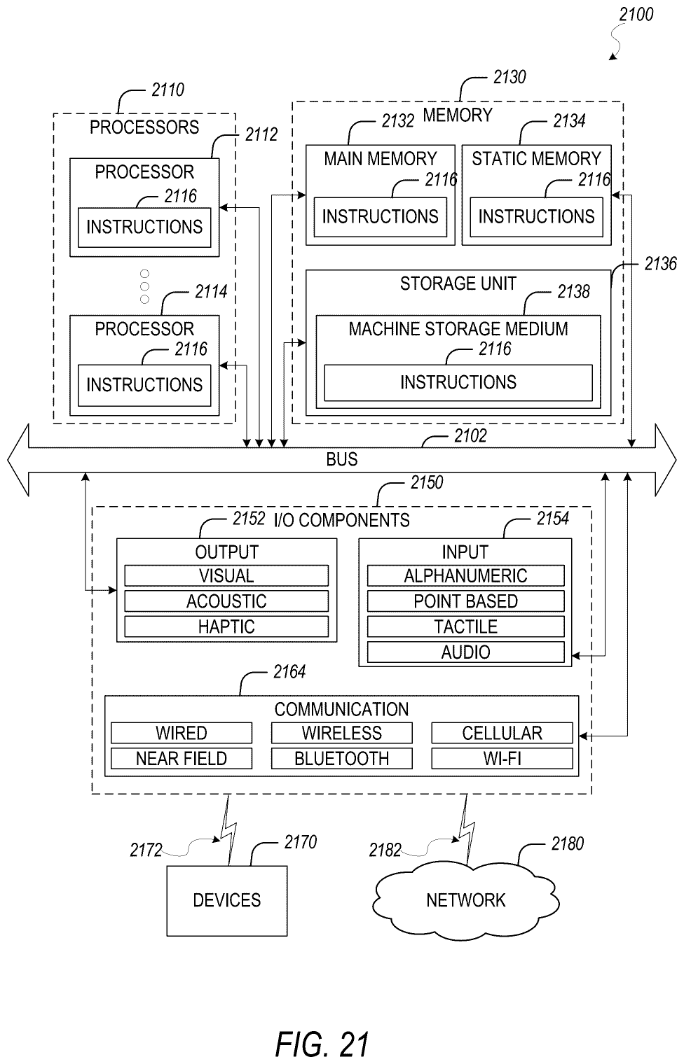

The various embodiments that are described herein are described with reference, where appropriate, to one or more of the various figures. An example computing environment using a DT manager to configure DTs to create, maintain, and consume cost-effective, continuous data pipelines and perform zero-copy clones of DTs is discussed in connection with FIGS. 1-3. Example configuration and functions associated with the DT manager are discussed in connection with FIGS. 4-20. A more detailed discussion of example computing devices that may be used in connection with the disclosed techniques is provided in connection with FIG. 21.

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not explicitly described herein. In other embodiments, the computing environment may comprise another type of network-based database system or a cloud data platform. For example, in some aspects, the computing environment 100 may include a cloud computing platform 101 with the network-based database system 102, storage platforms 104, and cloud storage platforms 122. The cloud computing platform 101 provides computing resources and storage resources that may be acquired (purchased) or leased (e.g., by data providers and data consumers), and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the DT-related functions described herein). The cloud computing platform 101 may include a three-tier architecture: data storage (e.g., storage platforms 104 and 122), an execution platform 110, and a compute service manager 108 providing cloud services (e.g., services associated with zero-copy cloning of DTs using a DT manager 128).

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform, which is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage), client device 114 (e.g., a data provider), and data consumer 116 via network 106. The network-based database system 102 is a network-based system used for reporting and analysis of integrated data from one or more disparate sources, including one or more storage locations within the cloud storage platform 104. The storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services (as well as additional services such as the disclosed DT-related functions) to multiple client accounts, including an account of the data provider associated with client device 114 and an account of the data consumer 116. In some embodiments, the compute service manager 108 comprises the DT manager 128, which can be used in connection with DT-related functions. Example DT-related functions include configuring zero-copy cloning of DTs, configuring DTs to compute changes in the results of a query, merging these changes into a table to perform an incremental update, storing aggregates that can be incrementally updated, and breaking up complex queries into separate, inter-dependent tables (e.g., in connection with performing an incremental refresh). A more detailed description of the functions provided by the DT manager 128 is provided in connection with FIGS. 4-20.

The compute service manager 108 coordinates and manages operations of the network-based database system 102. The compute service manager 108 also performs query optimization and compilation and manages clusters of computing services that provide compute resources (also referred to as “virtual warehouses”). The compute service manager 108 can support any number of client accounts, such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 114. The client device 114 corresponds to a user of one of the multiple client accounts (e.g., a data provider) supported by the network-based database system 102. The data provider may utilize application connector 118 at the client device 114 to submit data storage, retrieval, and analysis requests to the compute service manager 108 as well as to access or configure other services provided by the compute service manager 108 (e.g., services associated with the disclosed DT-related functions).

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some aspects, a data consumer 116 can communicate with the client device 114 to access functions offered by the data provider. Additionally, the data consumer can access functions (e.g., DT-related functions) offered by the network-based database system 102 via network 106.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

In some embodiments, communication links between elements of the computing environment 100 are implemented via one or more data communication networks, such as network 106. The one or more data communication networks may utilize any communication protocol and any type of communication medium. In some embodiments, the data communication networks are a combination of two or more data communication networks (or sub-networks) coupled with one another. In alternate embodiments, these communication links are implemented using any communication medium and any communication protocol.

The compute service manager 108, metadata database 112, execution platform 110, and storage platform 104 are shown in FIG. 1 as individual discrete components. However, each of the compute service manager 108, metadata database 112, execution platform 110, and storage platforms 104 and 122 may be implemented as a distributed system (e.g., distributed across multiple systems/platforms at multiple geographic locations). Additionally, each of the compute service manager 108, metadata database(s) 112, execution platform 110, and storage platforms 104 and 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operations, the network-based database system 102 processes multiple jobs as determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from and store data to any of the data storage resources in the cloud storage platform 104.

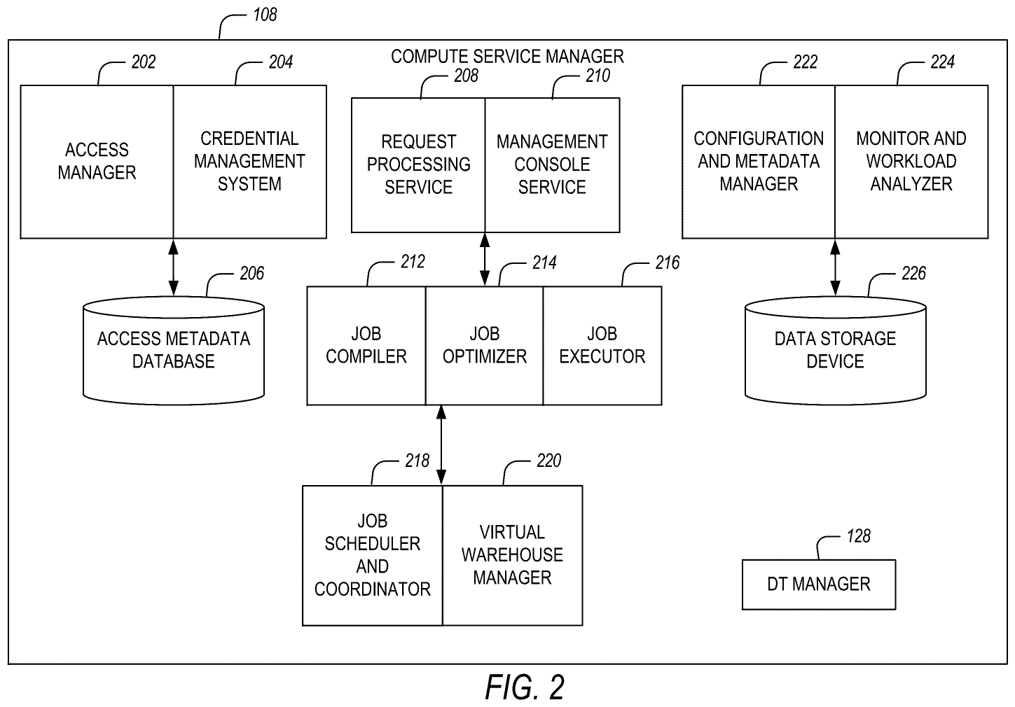

FIG. 2 is a block diagram illustrating components of the compute service manager 108, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources, such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs, such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and the local buffers (e.g., the buffers in the execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2) and should be disallowed from communicating with a third execution node (e.g., execution node 312-1) and any such illicit communication can be recorded (e.g., in a log or other location). Also, the information stored on a given execution node is restricted to data relevant to the current query, and any other data is unusable, rendered so by destruction or encryption where the key is unavailable.

In some embodiments, the compute service manager 108 further includes the DT manager 128, which can be used in connection with DT-related functions disclosed herein. The DT-related functions can include configuring zero-copy cloning of DTs, configuring DTs to compute changes in the results of a query, merging these changes into a table to perform an incremental update, storing aggregates that can be incrementally updated, and breaking up complex queries into separate, inter-dependent tables (e.g., in connection with performing an incremental refresh)

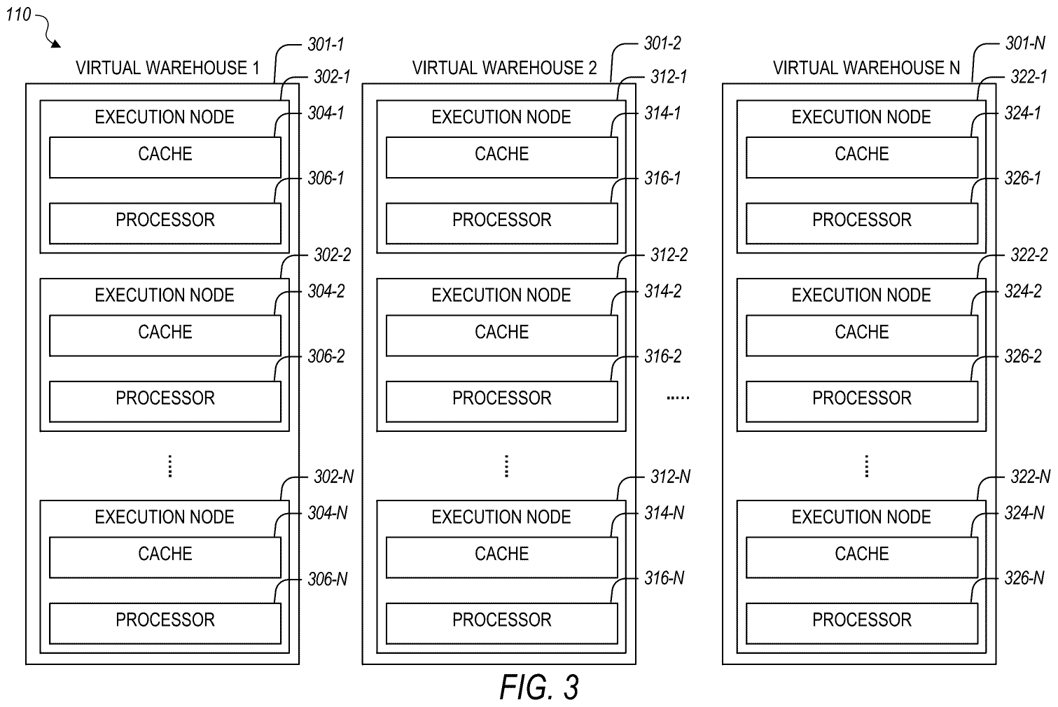

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic so that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and; instead, they can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes: 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes: 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes: 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, which is helpful for tasks that require fast scanning of large amounts of data. In some embodiments, the cache resources and computing resources associated with a particular execution node are determined when the execution node is created based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location. In contrast, virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

In some aspects, DTs can be configured with the following capabilities:
(a) Incremental refresh: selection, projections (scalar functions), aggregations, and joins (inner, outer, semi, anti). In some aspects, DTs are refreshed incrementally (e.g., when the DTs contain the above-listed operations).
(b) Observability: In some aspects, a user interface (UI) with a simple view graph and account usage views can be used for monitoring.
(c) DT definition evolution can be used to configure a full refresh. In some aspects, DTs can continue functioning when they are replaced. However, updating may be based on a full (non-incremental) refresh. If consuming DTs are broken, updates may pause, and an error may be generated.
(d) Shared data: In some aspects, DTs can read shared tables and views and share them themselves.
(e) Data transformation tool (e.g., DBT) integration: a custom DBT materialization for users can be used to adopt DTs in data transformation pipelines.

In some aspects, the disclosed techniques can be used to create DTs with the following configurations: minimum lag of 1 second; nesting depth, fan-in, and fan-out of up to 1000; incremental refreshes for partitioned window functions, subqueries, lateral joins, and recursive queries; integration with other data processing features including streams, row access policies, column masking policies, external tables, directory tables, external functions, user-defined functions (UDFs), and user-defined table functions (UDTFs); support for non-deterministic functions; an interactive UI for monitoring and debugging DT pipelines; incremental DT definition evolution when queries change compatibility; automatic query rewrites into DT scans; stream-like, “append-only” transformations; continuous DML features; merge performance optimizations; and using DTs to implement other features.

In some aspects, DTs can be defined and orchestrated using data definition language (DDL) commands. For example, a DT can be created using the command CREATE DYNAMIC TABLE <name> [LAG=<duration>] AS<query>. In this regard, a DT can be created using a query on one or more base tables and a lag duration (also referred to as a lag or a lag duration value). The lag duration value indicates a maximum period that a result of a prior refresh of the query can lag behind a current real-time instance (e.g., a current time, which can also be referred to as a current time instance). The lag duration value can be configured as a required parameter.

In some aspects, the DDL command ALTER DYNAMIC TABLE <name> {SUSPEND|RESUME} can be used to suspend or resume a refresh (e.g., to prevent refreshes without deleting DTs entirely).

In some aspects, the DDL command ALTER DYNAMIC TABLE <name>REFRESH can be used for the manual orchestration of data pipelines. In some aspects, the DDL command SHOW DYNAMIC TABLES can be similar to the command SHOW DYNAMIC VIEWS but with additional columns to show, e.g., lag, base tables, and maintenance plan. In some aspects, when the lag duration is set to infinity, the ALTER command can be used for a manual refresh.

In some aspects, the following DDL command configurations can be used with the disclosed DT-related techniques.

The following syntax may be used with the CREATE command for creating DTs: CREATE [OR REPLACE] DYNAMIC TABLE <name> (<column_list>) [LAG=<duration>] AS<select>. LAG represents a lag duration that the table is allowed to be behind relative to the current time. The term <select> indicates the view definition and may include a selection of both tables, views, projections (scalar functions), aggregates, joins (inner, outer, semi, anti), etc. This definition can be richer than an MV view definition.

In some aspects, if LAG is not specified and the user provides a view definition that is not compatible with the current implementation, then an informative error is generated that will point to a document that details what is allowed/not allowed. Examples of this include a selection on an MV (selects from materialized tables can be allowed, but not classic MVs). Similar to existing MVs, creation requires CREATE MATERIALIZED TABLE privileges on the schema and SELECT privileges on the base tables and sources.

The following configurations may be used with the ALTER command. The command can be configured as ALTER MATERIALIZED TABLE <name> {SUSPEND|RESUME}. This command allows the user to stop the DT from updating itself via its refresh strategy. A DT can remain suspended until a RESUME is executed.

In some aspects, the command ALTER MATERIALIZED TABLE <name> set LAG=<duration> can be used to change the lag of the materialized table. The subsequent scheduled execution of the refresh can reflect the updated lag.

In some aspects, the command ALTER MATERIALIZED TABLE <name>REFRESH [AT (<at_spec>)] can be used to initiate an immediate refresh of the DT. This command may be used with data engineering use cases that may require more direct control over refreshes. For example, it may be common for imperative data pipelines to spend a significant amount of time in an inconsistent state, with new data only partially loaded. Authors of such pipelines would not want a refresh to occur during these inconsistent periods, and they may disable automatic refresh (LAG=‘infinity’) and invoke REFRESH when they know the database is in a consistent state.

In some aspects, the optional AT clause can be used to allow users to control the transactional time from which the DT's source data is read. Using this, they can ensure that multiple manually-orchestrated DTs are aligned correctly, even during backfills.

In some aspects, commands ALTER DYNAMIC TABLE <name> set REFRESH_MODE={INCREMENTAL|FULL|AUTO} and ALTER DYNAMIC TABLE <name> unset REFRESH_MODE can be used to change the refresh mode on the DT. The change can be reflected in the next reprocessing of the DT. Unset sets the refresh mode back to the system default. The INCREMENTAL value may be used to maintain the DT by processing changes to the source(s) incrementally. The FULL value may be used to perform a full refresh of the DT (i.e., an entire re-computation). The AUTO value indicates that the network-based database system can determine whether to perform an incremental or full refresh, any may alternate between the two depending on upstream changes and the view definition.

In some aspects, the DROP DYNAMIC TABLE <name> command can be configured.

In some aspects, SHOW DYNAMIC TABLES [LIKE ‘<pattern>’] [IN {ACCOUNT|DATABASE [<db_name>] |[SCHEMA] [<schema_name>]}] command can be configured. The existing syntax can be kept, but the following columns can be added to the existing output:
(a) lag: the user-defined lag duration specified during creation. This configuration can be static, unlike the existing columns.
(b) source_names: a column that has the fully qualified names of the sources used in the DT as a list, ex. [“db”. “schema”. “table”]. For a longer term, source_database_name, source_schema_name, and source_table_name can be deprecated in favor of this new column as these will be null for DTs.

In some aspects, the following variants of the EXPLAIN command may be used in connection with the disclosed DT-related functionalities (e.g., to obtain details of an operation on a DT):
(a) EXPLAIN CREATE DYNAMIC TABLE <mv> LAG=<duration> AS<query> can be used to show the refresh plan before creating a DT.
(b) EXPLAIN ALTER DYNAMIC TABLE <mv>REFRESH [AT (<at_spec>)] can be used to show the refresh plan for an extant DT.
(c) EXPLAIN SELECT <select> FROM <mv> can be used to show the version and plan used to resolve the DT.

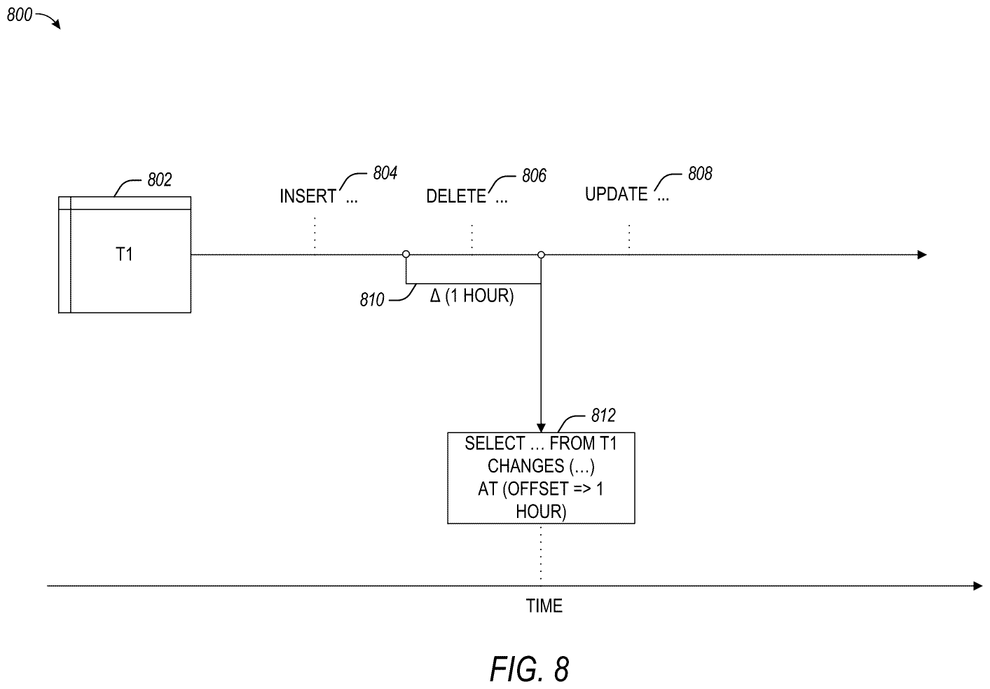

In some aspects, a stream on a DT can be created, similarly to a stream on a view (which is discussed in connection with FIG. 8-FIG. 12).

FIG. 4 is diagram 400 illustrating an example data enrichment pipeline using DTs, in accordance with some embodiments of the present disclosure.

In some aspects, DT definitions are rendered into a dependency graph, where each node in the graph is a DT query, edges indicate that one DT depends on the results of another, leaf nodes are DTs on base tables, and DDLs (e.g., DDL commands) can be used to log graph changes to a metadata database (e.g., metadata database 112), and an in-memory representation of the graph can be rendered.

Referring to FIG. 4, DT Enriched1 404 is created using a subset of base tables 402, namely, base tables Facts and Dim1. DT CleanDim2 406 is created using base table Dim2 of base tables 402. DT Enriched2 408 is created from DTs Enriched1 and CleanDim2. In this regard, the following processing sequence can be used: (a) a DT is created using other DTs; (b) the DTs (e.g., the DTs 404-408 in FIG. 4) form an acyclic dependency graph (e.g., a directed acyclic graph or DAG); a query in the final DT (e.g., DT Enriched2 408) is parsed to obtain two or more dependent DTs (e.g., DTs Enriched1 404 and CleanDim2 406); and DT refreshes can be scheduled based on the configurations of each DT.

In some aspects, DT refreshes can be scheduled at aligned time instances (or ticks) for consistency. In some aspects, DTs can be joined at consistent times without fine-grained refreshes. A user can provide a lag duration (or lag) target, and refreshes can be scheduled to meet that target. For example, a set of canonical refresh times (e.g., ticks) is selected, which align refreshes at different frequencies. In some aspects, the ticks can be determined based on the following equation: ticks={UnixEpoch+48 seconds*2^{f}*n}, where f is the frequency level, and n is the refresh instance. In some aspects, refreshes can be scheduled at the nearest tick that meets the user's lag target. Common examples of lag targets and tick periods are provided in Table 1 below:

TABLE 1

| | | | | | | | | | | |
|---|---|---|---|---|---|---|---|---|---|---|
| Target | 1 | min | 5 | min | 15 | min | 1 | hr | 25 | hr |
| Lag | | | | | | | | | | |
| Tick | 48 | sec | 3.2 | min | 12.8 | min | 51 | min | 13.6 | hr |
| Period | | | | | | | | | | |

Using the above techniques can yield alignment at two scopes: account-wide (DTs can be joined with snapshot isolation) and deployment-wide (DTs can be joined with read-committed isolation).

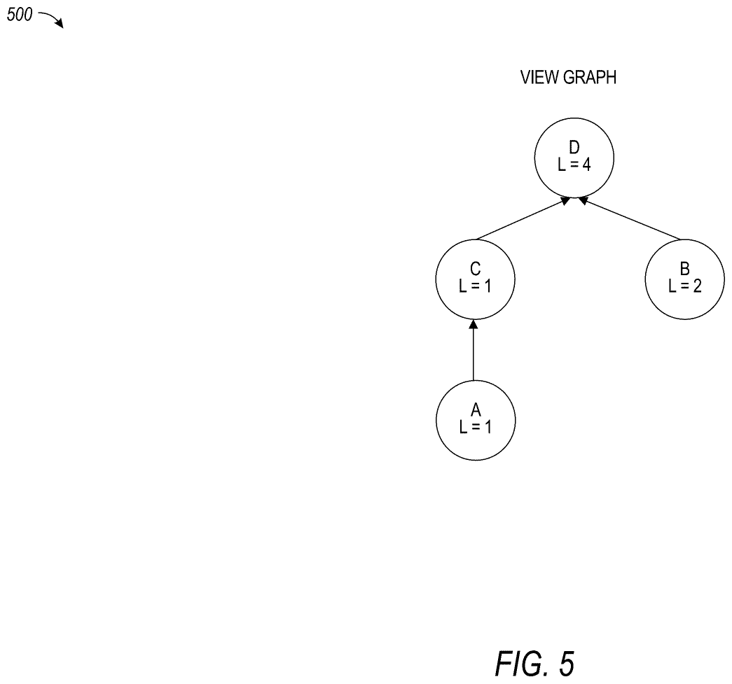

FIG. 5 is a diagram of a view graph 500 of DTs associated with different lag targets, in accordance with some embodiments of the present disclosure. Referring to FIG. 5, graph 500 is associated with a dependency relationship between DTs with different lag durations (indicated as L). For example, DT A (with lag duration L=1) feeds to DT C (with L=1). DT D (with L=4) uses data from DT C (L=1) and DT B (L=2).

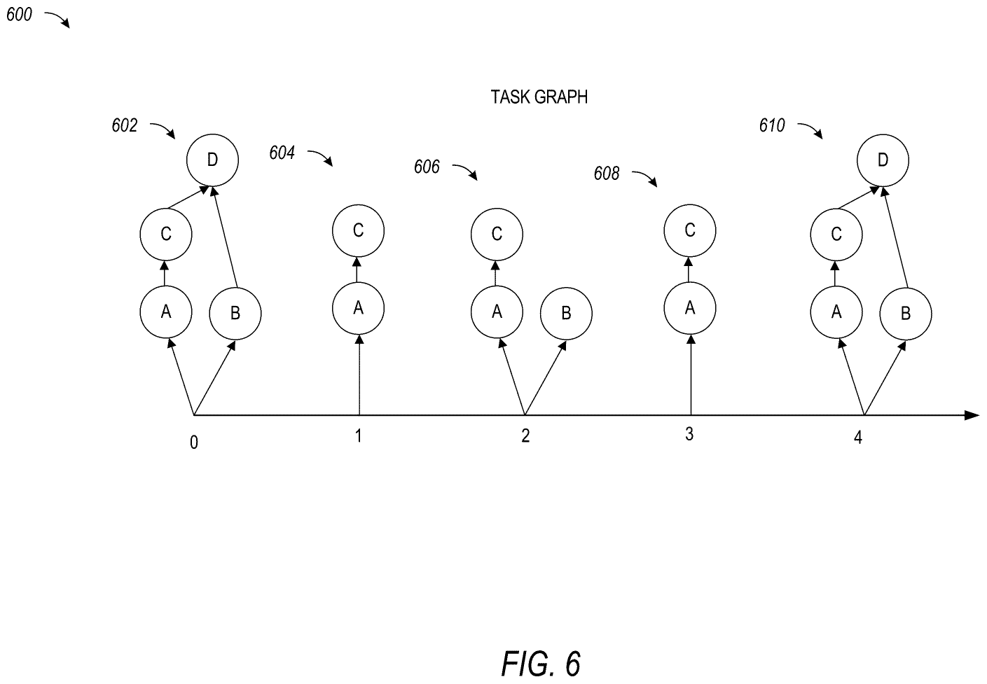

FIG. 6 is a diagram of a task graph 600 of DTs associated with scheduled refreshes at different times according to individual lag targets, in accordance with some embodiments of the present disclosure. Referring to FIG. 6, graph 600 shows scheduled refreshes of DT groups 602, 604, 606, 608, and 610 at corresponding ticks 0, 1, 2, 3, and 4. More specifically, graph 600 shows scheduled refreshes of the DTs of FIG. 5 based on their lag durations. At time instances 0 and 4 (or ticks 0 and 4), all DTs (A, B, C, and D) are refreshed. At ticks 1 and 3, DTs A and C are refreshed, and at tick 2, DTs A-C are refreshed.

As illustrated in FIG. 6, DTs can be refreshed with different refresh cadences based on the corresponding DT lag durations. In some aspects, the refresh cadences can be configured so that when the DTs are refreshed, the DTs always produce results that their corresponding queries would have produced at some point in time.

In some aspects, a refresh can be configured to execute a maintenance plan that updates the DT's physical table. In some aspects, at each tick, a rooted prefix of the DAG (e.g., the DT dependency graph) can be refreshed. A consistent snapshot of the DAG can be maintained in memory, and a compute service task can be scheduled for each connected component. The connected component task can enter a scheduling loop, which finds nodes with satisfied dependencies and starts a refresh job. In some aspects, a refresh job has a maintenance plan, which can take one of the following forms: (1) a full refresh (truncate the DT table and insert the result of running the DT definition at the tick time); and (2) incremental refresh (compute the changes in the DT since the last refresh tick and merge them into the DT table).

In some aspects, the refresh job creates table versions at the tick time. New DT table versions can be configured with a new property containing the base tables' version IDs. Retries can skip re-computation if the version has already been computed. Additionally, queries can resolve the correct version by specifying an entity version AT (DT_BASE_TIME=><ts>).

The following maintenance plan configurations can be used with the disclosed DT-related functions. The disclosed configurations can be used for the maintenance of DTs via full refreshes and incremental updates. The disclosed design configuration can be used to ensure that DT updates preserve the DT history, which can be essential for time-travel queries to produce consistent results and for computing the updates of downstream views.

In some aspects, DTs can be maintained in the following two ways:
(a) Incremental Update. For an update tick, the set of delta changes (delta set) since the last update is computed and merged into the DT. This technique can use the following configurations: (1) all operations of the DT definition are supported for incremental maintenance, and (2) all base relations provide access to their history and can provide their delta sets.
(b) Full Refresh. For each update tick, the view definition is recomputed, and the DT is fully replaced. This technique can be used if the DT definition includes operations that are not yet supported for incremental updates or if it is not possible (or feasible) to retrieve the delta set of a based relation.

In some aspects, incremental updates and full refreshes can be dynamically switched from one to the other (e.g., based on a detected data processing latency characteristic or other configuration settings).

In some embodiments, all rows in a DT can be uniquely identifiable by a ROW_ID metadata attribute. The ROW_ID attribute can be used to match changes from the delta set with the rows in the DT or compute delta sets from a DT that is fully refreshed (e.g., depending on the size of the DT, this can be beneficial because it allows for incremental maintenance of downstream views). Hence, each DT can have a ROW_ID metadata column (which corresponds to the metadata columns of tables with enabled change tracking).

Example requirements for the ROW_ID include incremental and at-once computation of the ROW_ID that may yield the same value, and collisions of ROW_IDs may result in data corruption. In some aspects, unique mechanisms may be used if base relations are referenced multiple times (self-join, self-union-all, . . . ). Generation can be insensitive to plan changes (join order, input order, . . . ). In some aspects, runtime validation ROW_IDs can be expensive for production, but a debug mode can be added for tests (e.g., full column comparisons for DELETE and UPDATE changes and uniqueness check for INSERT changes can be performed). In some aspects, streams on views can be used to address the ROW_ID requirements.

In some aspects, the following configurations may be used for incremental update maintenance of DTs. Given a delta set (e.g., a set of changes applied to a DT such as an Insert, a Delete, or an Update) for a DT, it can be applied to the DT in two ways:
(a) Single MERGE command. All changes (e.g., encompassed by the delta set) are applied with a single MERGE DML. Updates are processed as upserts (or merges) on the ROW_ID merge key. The following pseudo-code in Table 2 can be used for performing the MERGE command.

```
TABLE 2
MERGE INTO dt m
USING (
  SELECT *, metadata$action, metadata$isupdate, metadata$row_id
  FROM delta_set
  WHERE
    -- upsert on ROW_ID doesn't require the DELETE of an UPDATE change
    NOT (metadata$action = ‘DELETE’ AND metadata$isupdate = TRUE)) AS d
ON m.metadata$row_id = d.metadata$row_id
WHEN MATCHED AND metadata$action = ‘DELETE’
  THEN DELETE
WHEN MATCHED AND metadata$action = ‘INSERT’ AND metadata$isupdate
= TRUE
  THEN UPDATE SET m.* = d.*, m.metadata$row_id = d.metadata$row_id
WHEN NOT MATCHED AND metadata$action = ‘INSERT’ AND
metadata$isupdate = FALSE
  THEN INSERT (*, m.metadata$row_id) VALUES (d.*, d.metadata$row_id);
```

(b) A MERGE command followed by an INSERT command. The DELETE and UPDATE changes of the delta set can be applied with a MERGE DML command. The INSERT changes can be applied later with a separate INSERT DML command. The following pseudo-code in Table 3 can be used for performing the MERGE command followed by the INSERT command.

```
TABLE 3
MERGE INTO dt m
USING (
  SELECT *, metadata$action, metadata$isupdate, metadata$row_id
  FROM delta_set
  WHERE
    -- upsert on ROW_ID doesn't require the DELETE of an UPDATE change
    NOT (metadata$action = ‘DELETE’ AND metadata$isupdate = TRUE)
    -- INSERT changes are applied with subsequent INSERT DML
    AND NOT (metadata$action = ‘INSERT’ AND metadata$isupdate = FALSE)
AS d
ON m.metadata$row_id = d.metadata$row_id
WHEN MATCHED AND metadata$action = ‘DELETE’
  THEN DELETE
WHEN MATCHED AND metadata$action = ‘INSERT’ AND metadata$isupdate
= TRUE
  THEN UPDATE SET m.* = d.*, m.metadata$row_id = d.metadata$row_id;
INSERT INTO dt(*)
SELECT d.*
FROM delta_set d
WHERE metadata$action = ‘INSERT’ AND metadata$isupdate = FALSE;
```

The above processing can reduce the amount of data to match during a MERGE. The delta set may be persisted to consume from both DMLs.

In some aspects, using ROW_ID as a merge key may create a performance issue (e.g., artificial join keys have a wrong locality and can result in inferior performance; an additional merge key may need to be added).

In some aspects, the MERGE, as configured by both approaches, may require a perfect delta set without duplicate keys. However, deduplicating changes to obtain a perfect delta set can be costly. Streams can produce perfect delta sets, and no deduplication is needed. Bitsets may reduce the cost to derive delta sets with duplicates significantly such that they outperform perfect delta sets. In some aspects, the MERGE can be configured to deduplicate merge keys. In some aspects, the delta streams can be used to address redundancies (e.g., an insert and delete with the same row ID and the same values for all columns). More specifically, delta streams can filter out redundancies, and bitsets can reduce the number of such redundancies substantially.

In some aspects, the following configurations may be used for full refresh maintenance. A full refresh set can be computed by evaluating the view definition (enriched by the computation of the ROW_ID attribute) on a consistent version of all base relations. The refresh set can be applied in two ways:

(1) Full replacement: deletes all rows of the DT and inserts all rows of the refresh set. Commands listed in Table 4 can be used for a full replacement.

TABLE 4

DELETE FROM dt;
INSERT INTO dt(*)
SELECT f.*
FROM full_set f;

In some aspects, the ROW_ID ensures that a delta set can be computed from the fully refreshed DT. Depending on the DT size, this processing may be expensive because a full scan and processing of both versions of the DT may be needed.

(2) Merging Changes: compute the differences between both DT versions and evolve the DT into the new version. First, delete all rows that are no longer in the new version, then update all rows that were modified and insert all new rows with a MERGE DML. Commands listed in Table 5 can be used for merging changes.

```
TABLE 5
DELETE FROM dt m
WHERE m.metadata$row_id NOT IN (
SELECT metadata$row_id FROM full_set);
MERGE INTO dt m
USING full_set f
ON m.metadata$row_id = f.metadata$row_id
-- update record
WHEN MATCHED AND m.* <> f.*
  THEN UPDATE SET m.* = d.*, m.metadata$row_id = d.metadata$row_id;
-- insert record
WHEN NOT MATCHED
  THEN INSERT (*, m.metadata$row_id) VALUES (d.*, d.metadata$row_id);
```

In some aspects, merging changes can be more expensive than fully replacing the DT. However, it may be cheaper to extract a delta set from a DT that was updated by merge because fewer records might have been changed. The initial approach to applying full refresh sets can be a full replacement.

In some aspects, delta sets can be persisted as temporary tables. This allows for merging the delta set in multiple steps (e.g., MERGE for UPDATE/DELETE and INSERT), computing and persisting the delta set before the previous delta has been applied on the DT (e.g., defer merging until DT is on the right version), and scan delta set from the persisted table instead of computing it from DT's history when updating downstream DTs.

After the delta set is merged to its DT and all downstream DTs are updated, the temporary table can be deleted.

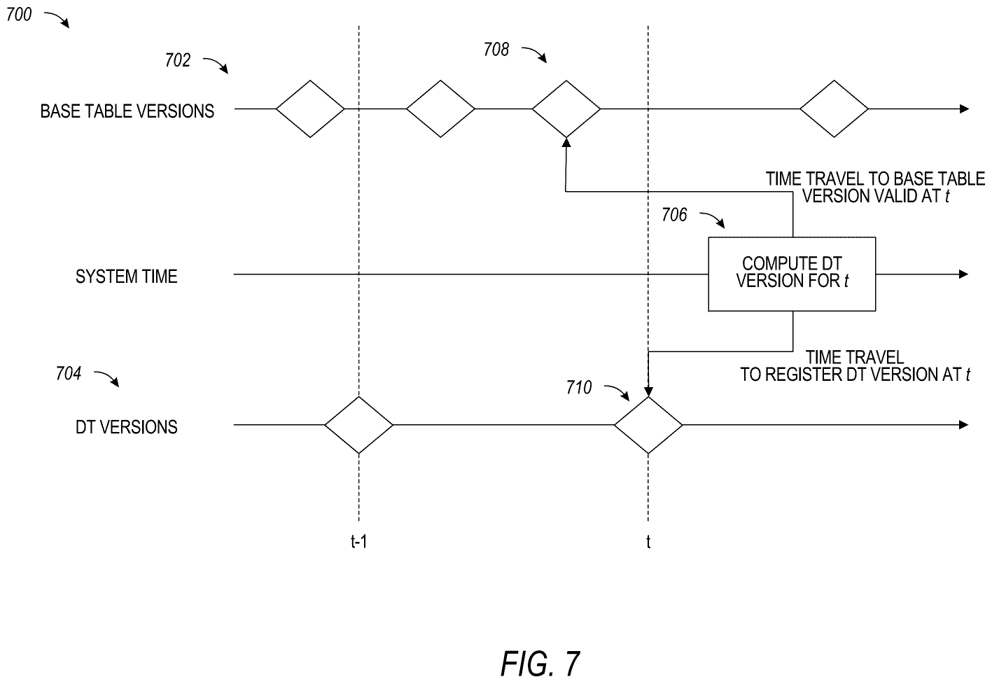

FIG. 7 is diagram 700 illustrating the use of data manipulation language (DML) commands and time travel queries to compute an updated set of a DT with respect to specific versions of its base relations, in accordance with some embodiments of the present disclosure.

In some aspects, the table versions 704 of DTs may be aligned with the base table versions 702 of their corresponding base tables. Using time travel queries (e.g., query 706), the update set of a DT 710 may be computed concerning specific versions (e.g., base table 708) of its base relations (e.g., as illustrated in FIG. 7). The new DT version that results from merging the update set in alignment may be registered with the versions of its base relations. Hence, capabilities for the DMLs that update DTs may also be configured. The following describes how to register table versions for DTs and how to look up their versions when they are queried for a specific time.

In some aspects, DML commands that create table versions at a specific time in a DT's base tables' time domain can be configured. The base version time of a new version can be assumed to be after all preceding DT table version base times. Additionally, reads can resolve table versions in this time domain.

In some aspects, streams on DTs can be configured similarly to streams on views (e.g., as discussed in connection with FIGS. 8-12).

FIG. 8 is a diagram 800 of using a CHANGES clause in connection with query processing, in accordance with some embodiments of the present disclosure. Referring to FIG. 8, queries or data processing commands Insert 804, Delete 806, and Update 808 are applied to source table 802. As illustrated in FIG. 8, the SELECT statement 812 may be used to return the changes that occurred to the source table 802 during period 810 (e.g., one hour).

As used herein, the term “stream” refers to a table and a timestamp. In some aspects, a stream may be used to iterate over changes to a table. When a stream is read inside a Data Manipulation Language (DML) statement, its timestamp may be transactionally advanced to the greater timestamp of its time interval.

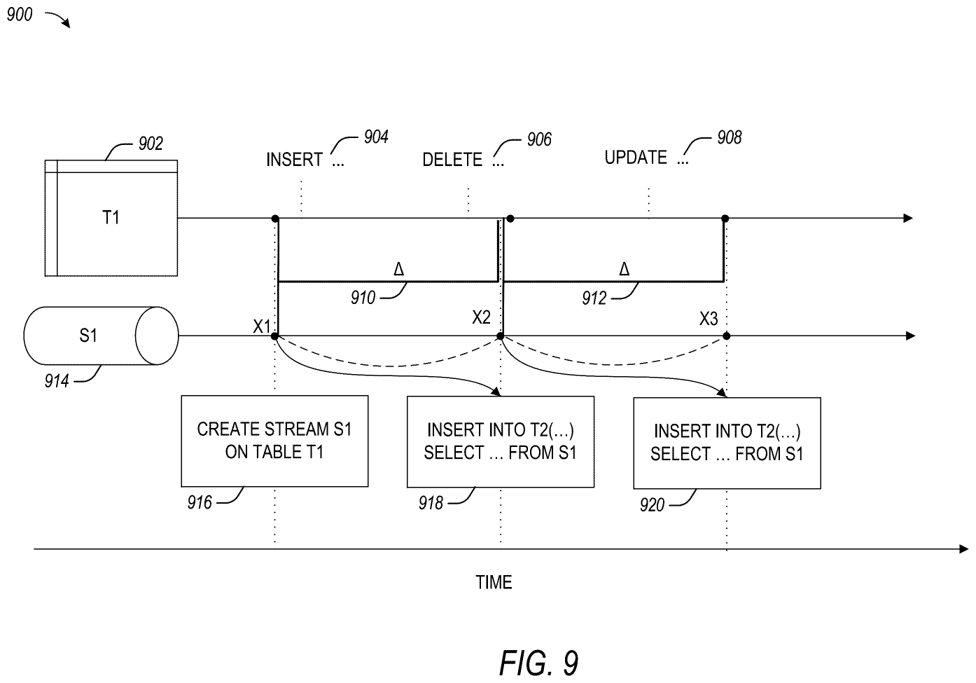

FIG. 9 is diagram 900 of a stream object configuration for a table, in accordance with some embodiments of the present disclosure. Referring to FIG. 9, queries or data processing commands Insert 904, Delete 906, and Update 908 are applied to source table 902. As illustrated in FIG. 9, a stream 914 is generated on source table T1 902 at times X1, X2 (after a time interval of 910 from X1), and X3 (after a time interval of 912 from X2). Additionally, at operation 916, stream S1 is created on table T1. At operation 918, stream S1 produces the changes in T1 from time X1 to time X2, which are inserted into table T2. At operation 920, stream S1 produces the changes in T1 from time X2 to time X3, which are inserted into table T2.

As used herein, the term “access control” indicates that customers can control who can access database objects within their organization.

As used herein, the term “data sharing” indicates that customers can grant access to database objects to other organizations.

In some aspects, any query with a CHANGES clause or a stream may be referred to as a change query. A change query on a view may be defined similarly.

In some embodiments, the DT manager 128 is configured to provide changes to views (e.g., a stream on views) so that the changes may be further processed and acted on. More specifically, the DT manager 128 may be configured to provide or process streams on views in connection with the following three use cases: shared views, complex views, and view evolution. In some aspects, more than one use case may apply at a given time.

Shared (secure) views may be used to provide (e.g., a user or organization) limited access to sensitive data. The consumer of the data often wishes to observe changes to the data being shared with them. Some considerations implied by this use case include giving the consumer visibility into the shared view's retention period and how to enforce secure view limitations on change queries.

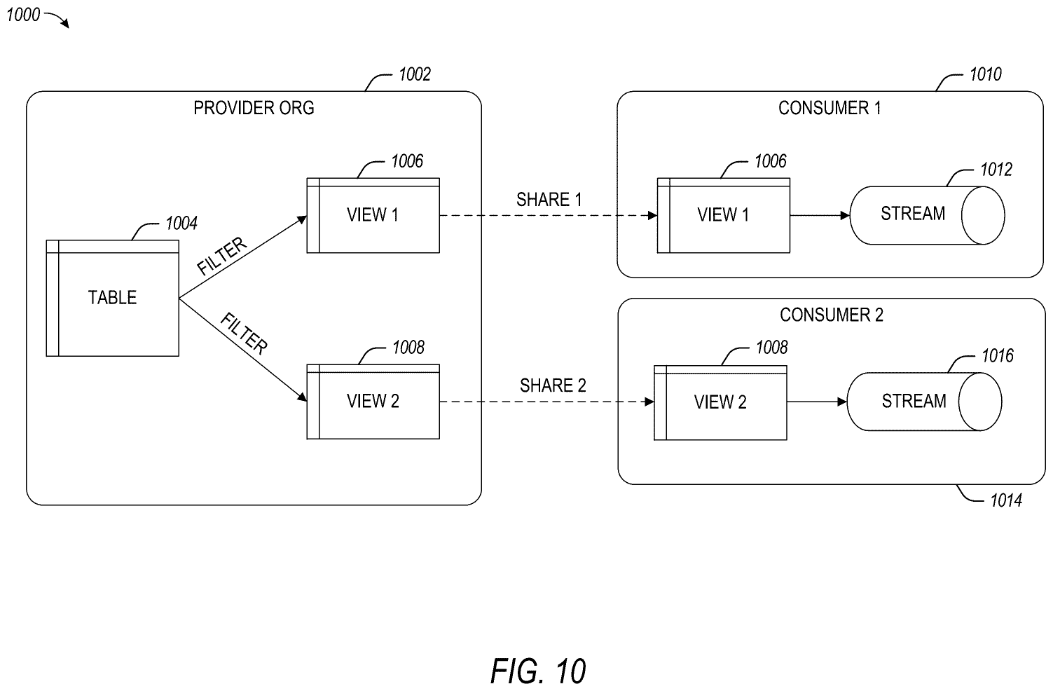

FIG. 10 is a diagram 1000 of shared views, in accordance with some embodiments of the present disclosure. Referring to FIG. 10, a data provider 1002 manages a source table 1004. The data provider 1002 applies different filters to source table 1004 to generate views 1006 and 1008. View 1006 is shared with consumer 1010, and view 1008 is shared with consumer 1014. In some embodiments, the DT manager 128 is used for configuring streams 1012 and 1016 on corresponding views 1006 and 1008 for consumption by consumers 1010 and 1014.

The definition of a view can be quite complex, but observing the changes to such a view may be useful regardless of its complexity. Manually constructing a query to compute those changes may be achieved, but it can be laborious, error-prone, and suffer from performance issues. In some aspects, a change query on a view may automatically rewrite the view query, relieving users of this burden. In some aspects, simple views containing only row-wise operators (e.g., select, project, union all) may be used. In some aspects, complex views that join fact tables with (potentially several) slowly changing dimension (DIM) tables may also be used. Other kinds of operators like aggregates, windowing functions, and recursion may also be used in connection with complex views.

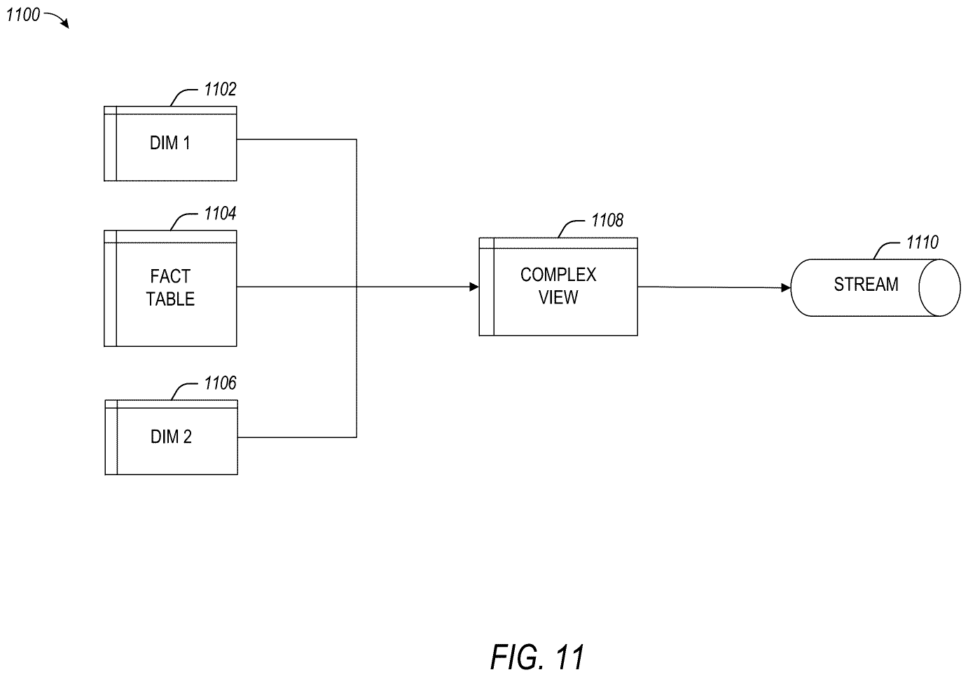

FIG. 11 is diagram 1100 of a stream object based on a complex view, in accordance with some embodiments of the present disclosure. Referring to FIG. 11, a complex view 1108 may be generated based on source tables 1102, 1104, and 1106. In some embodiments, the DT manager 128 configures a stream 1110 based on the complex view 1108 of source tables 1102, 1104, and 1106.

In some aspects, views may be used to create an abstraction boundary, where the underlying tables can be modified without consumers being aware. For example, a view over a table undergoing a backward-incompatible schema change may be replaced by a new query that presents the same data in a different query, causing a view evolution. In some aspects, change queries may work across view redefinition, allowing change observation to the view uninterrupted by modifications to its definition. Considerations for this use case may include schema compatibility and performance. Some view redefinitions may use full joins to resolve, and others, such as workflows involving table clones, could be resolved more efficiently.

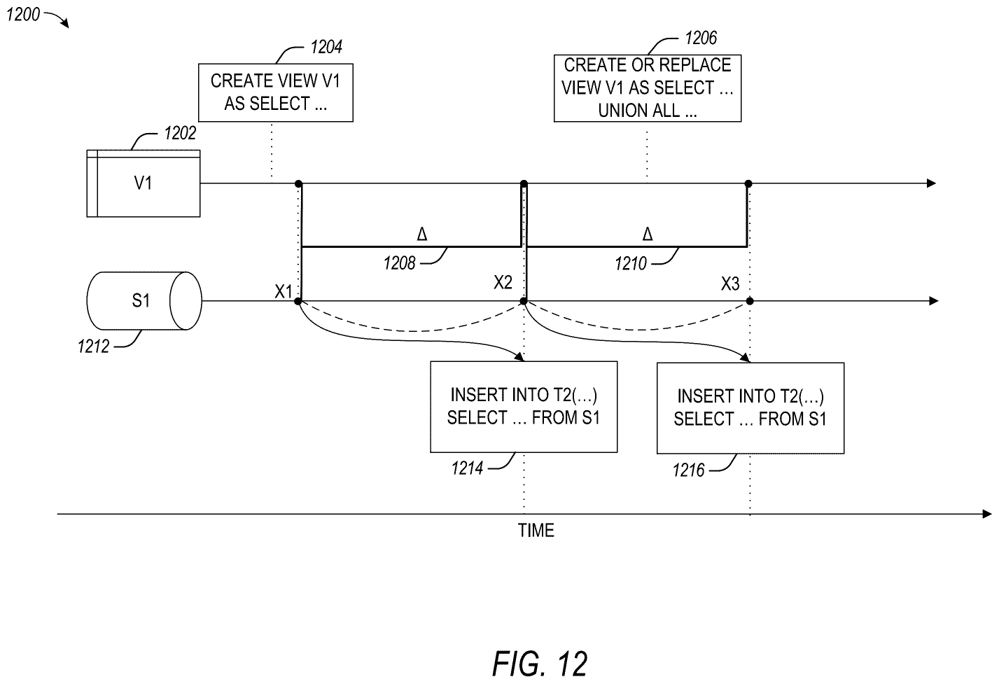

FIG. 12 is diagram 1200 of a view evolution, in accordance with some embodiments of the present disclosure. Referring to FIG. 12, at operation 1204, view V1 1202 is created based on a Select operation. Stream S1 1212 of view V1 1202 is generated at times X1, X2 (after a time interval of 1208 from X1), and X3 (after a time interval of 1210 from X2). Additionally, at operation 1214, a stream entry from stream S1 at time X2 is inserted into table T2. Before time X3, view V1 1202 evolves at operation 1206 when a union all operation is used. At operation 1216, a stream entry from stream S1 (based on the evolved view V1 at time X3) is inserted into table T2.

In some embodiments, to provide or process streams on views in connection with the above-listed use cases, the DT manager 128 may be configured with the following functionalities: intuitive semantics, unsurprising security, linear cost scaling, and easy operability.

In some aspects associated with intuitive semantics, change queries on views may work intuitively and consistently. The essence of a change query is to take a time-varying object and a time interval, then return a set of changes that explain the differences in the object over the interval. This definition applies naturally to views, but some additional configurations are addressed below.

As not all operations may be supported by the DT manager 128, property on views may be configured to allow change queries on it explicitly: CHANGE_TRACKING=true. When a view is created with this property enabled, a validation is performed that it only contains supported operators and the base tables have change tracking enabled. When a change query is issued on a view, it may succeed if the view has change tracking enabled.

In some aspects, a standing change query (e.g., a stream) may exhibit reference semantics. That is when a user specifies a view in a change query, such specification may be interpreted as referring to the view itself, not what the view is currently defined as. Adopting value semantics would likely result in surprising behavior, especially around access management.

Adopting reference semantics is associated with the ways a view can be modified. The following techniques may be used for view modifications:
(a) “ALTER VIEW . . . RENAME TO . . . ” When a view is renamed, objects referencing it may be updated. Complying with this precedent means a stream should break if its view is renamed.
(b) “ALTER VIEW . . . SET SECURE . . . ” If a view is made secure, subsequent change queries to it should enforce secure view constraints.
(c) “CREATE OR REPLACE VIEW.” If a view is replaced, there are processing choices. Per the View Evolution use case, some users may want the view to keep working as long as the replacement is schema-compatible. However, this may add complexity to the implementation.

In some aspects associated with unsurprising security, a consumer of a change query on a view may have the same access they have to the view itself. The following configurations may apply to all views: creating a stream on a view fails if the underlying tables do not have change tracking enabled and the creator does not have permission to enable it; consumers can see the minimum retention period of the tables referenced by a view (they cannot see which table the retention applies to); and if change tracking was enabled on a table in a view more recently than the beginning of the retention period, consumers can see when it was enabled.

In some aspects, the following configurations may be applied to secure views: consumers cannot see the view's definition; consumers cannot issue a change query before access is granted to the view; optimizations abide by secure view limitations (they do not reorder operators into the expanded view), and the retention period on a table in a secure view is not extended automatically to prevent a consuming stream from going stale.

In some aspects associated with linear cost scaling, a key attribute of change queries on tables is that their cost (both in terms of latency and credits) may be proportional to the result size. Append-only change queries may be introduced to work around cases when this scaling does not hold for delta queries. In some aspects, change queries on views may scale similarly in cost. That is, delta change queries and append-only change queries may scale proportionally to the result size.

In some aspects associated with easy operability, introducing change queries on views may increase the likely distance between the view provider and consumer (the shared views use case may revolve around this). The distance makes collaboration between provider and consumer more difficult. In turn, this means that a smooth operational experience for change queries on views is more critical than for traditional change queries. In some aspects, the following operational challenges may be addressed by the DT manager 128: handling view modification and surface errors.

In some aspects associated with the handling of view modifications, if the view provider renames or replaces their view, a stream on it will break. The consumer will then want to take action to repair it. The details of such repairs are use case-specific, but it may involve trying to recreate the stream with a new definition and resuming where the broken stream lets off. To support this, the DT manager 128 may be configured to support statements of the following form: CREATE OR REPLACE STREAM s . . . AT (STREAM=>s). The stream S is being both queried and replaced.

In some aspects associated with surface errors, consumers may try to issue change queries that are invalid for various reasons. The errors may be surfaced clearly to the consumer. Examples of such errors include: the underlying tables may not have change tracking enabled; the change query may be outside of the tables' retention period; the change query may contain unsupported operators; and the view may have been modified, breaking the change query.

View providers may have control over what happens to a view and any objects derived from it. However, they would benefit from visibility into how the view is being used to avoid accidentally breaking consumers. Examples of such notices include when the provider tries to make a breaking modification to a view, warn the provider that consumers will be disrupted; when consumers' change queries fail due to retention or change tracking, send the provider a notification; and support some introspection as well, such as a view provider looking up the number of streams consuming it and their offsets.

A stream object on tables (including external tables) may be configured to let the user retrieve a stream of changesets as the underlying data in the table changes. A stream object is configured to maintain a position in this list of changesets, and that position is only advanced if it is used in a DML statement.

Reading from the stream may return the changeset from the current position up to the current transaction timestamp. As the underlying data changes, the size of the changeset will grow until the stream is advanced. In some aspects, the advance may be transactional.

In some embodiments, the DT manager 128 is configured to create and process stream objects on views, in particular for data-sharing scenarios. In some aspects, shared data consumers may be able to get the latest changes from the shared data provider. Given that exposing shared data is done through secure views, a stream may be created on the consumer side on the view from the provider. In some aspects, streams on materialized views may also be configured to allow retrieving changesets as the underlying MV changes.

In some embodiments, providing changesets on a view (e.g., a query) is similar to the incremental materialized view maintenance problem. In the case of MVs, as the underlying data source(s) change, the materialized data set may be updated incrementally. In some aspects, this processing may be performed at the micro-partition level to create a query plan that uses the data from the added/deleted partitions and merges it with the MV data to produce the updated data.

In the case of a stream object (or stream) on a view, the changeset returned may be the delta of the data the view would return at the current transactional time compared to the data the view would return at the transactional time of the position of the stream. In some aspects, computing the delta efficiently may be a consideration since there may be no materialized data set that can be leveraged and incrementally updated. In some aspects, a materialized view may be created behind the scenes to mitigate this with the limitations of the queries MVs support today, which can make sense, especially for aggregate queries.

In some aspects, the delta for certain classes of queries may be generated efficiently (e.g., if there is only one data source). In that case, the data source of the view can be logically replaced with the delta provided by the stream on the data source. In some embodiments, the DT manager 128 may support projections and filters in the view as well. For example, data processing operators may be allowed where applying the operators on the delta provides the same result as computing the delta on the datasets at the two endpoints. In the initial solution, when the stream is created on a view, support for the view is validated, the data source table is located, and change tracking is set up for the table. When the data is requested from the stream, the underlying view in the query plan is expanded, and the data source table is replaced with generating the delta (similar to the processing applied if a stream on that table is configured in the first place). This processing may also be supported for secure views as well since the data source inside is swapped, and no outside filters would get pushed in.

In addition to maintaining the position of the start point of the change set, the stream may also implicitly expand the retention period on the underlying table up to two weeks depending on how far in the past of the table version history the stream position points. Such processing may also be performed for non-remote data sources. For shared data sources, the same mechanism may not be used because the table compaction status data on the remote side would need to be updated. In this regard, streams on shared data sources can go stale after a day, which is the default retention period for tables. To mitigate this effect, the provider of the shared data can increase the retention period on the table to allow more time for the stream on the provider side to be consumed (and advanced).

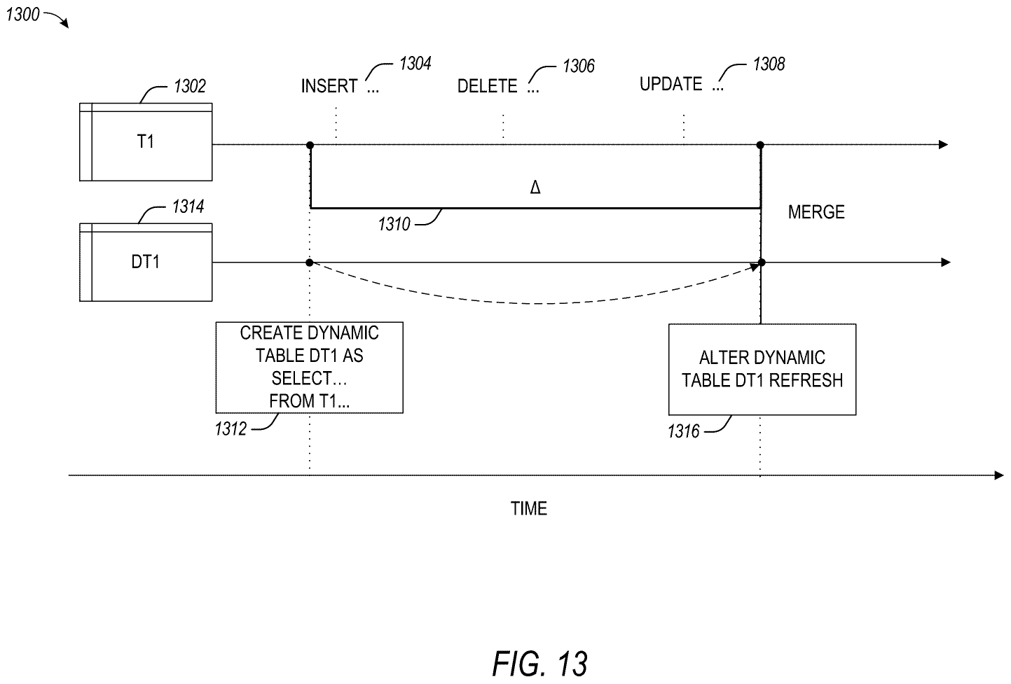

FIG. 13 is diagram 1300 of a DT refresh, in accordance with some embodiments of the present disclosure. Referring to FIG. 13, at operation 1312, a materialized table DT1 1314 is created as a select from base table T1 1302. A delta set 1310 can be computed for the base table 1302, which can include data changes based on an Insert operation 1304, a Delete operation 1306, and an Update operation 1308 applied to base table 1302. A refresh operation 1316 can be performed on DT1 1314 by merging the delta set 1310 with DT1 1314.

In some aspects, an incremental refresh of DTs can be configured using configurations and techniques discussed herein. An incremental refresh can be a more optimal function in place of computing the state of a DT every time a refresh is needed. During an incremental refresh, data is considered from the last time query results are computed, the difference between the query results and a new value is determined, and the determined change (or difference) is applied on top of the previous result.

The disclosed incremental refresh configurations can be used to handle several interdependent scenarios, which can make it challenging to partition into independent pieces. The scenarios are:
(a) Nested DTs: a DT queries another DT. Changes to one must be incrementally propagated to the other.
(b) Composite DTs: a single DT contains a sufficiently complex query that needs to be split into two or more DTs containing an intermediate state. A simple example of this scenario is COUNT (DISTINCT *).
(c) Query Facades: when querying a DT, the query plan may need to apply additional operations atop the intermediate state to compute the correct result. An example of this is AVG (_), which can be stored as SUM (_) and COUNT ( ) separately and then produced as the quotient.

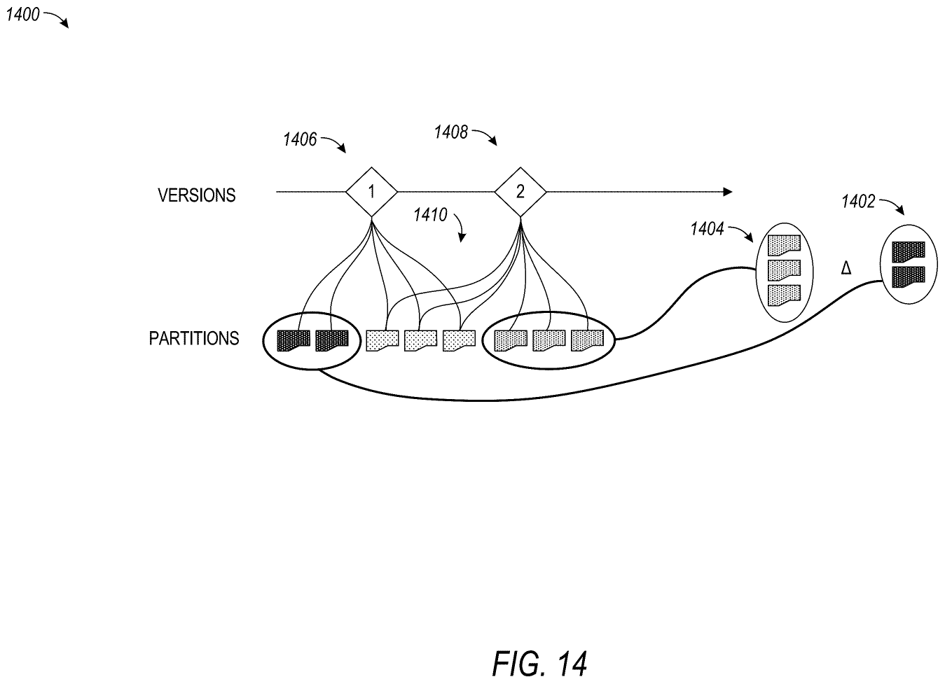

FIG. 14 is a diagram 1400 illustrating the determination of changes (or delta (Δ) or delta set) to a base table for a DT refresh, in accordance with some embodiments of the present disclosure. Referring to FIG. 14, a base table can be associated with versions 1406 and 1408 (also referenced as 1 and 2 in FIG. 14). To determine the delta set, the deleted files 1402 are determined, and the new (added) files 1404 are determined. The common files 1410 can be ignored for purposes of delta set determination. The delta set is the symmetric set difference of the rows in the deleted files 1402 and the rows in the added files 1404.

The disclosed techniques can be associated with the following terminology and corresponding definitions. The term MetadataFile Version refers to a chapter in a table's history. The first entry in the MetadataFile Version can be either a delta metadata file or a compacted metadata file. Each table version (also referred to as “Table Version”) can be mapped to a MetadataFile Version.

The term MetadataFile refers to a metadata file that contains a list of file partitions and various statistics about the data in the file partitions. Each Table Version can be mapped to a MetadataFile, where a MetadataFile is part of a MetadataFile Version. In some aspects, the DT manager 128 can use the following two types of MetadataFiles:
(a) Delta metadata (or delta file): It describes the changes made to the table by a DML (e.g., the list of files registered and unregistered, statistics about these files, etc.). In DBMS this can be equivalent to a log record.
(b) Compacted metadata (or compacted file): It describes the table's state up to that point in a concise form. Hence, it only contains the list of partitions and the statistics about those files, but it may not have historical information about how the table got to this state. In DBMS, this can be equivalent to a checkpoint.

When scanning a table, the DT manager can map the transaction's version (Table Version) to a MetadataFile Version. The DT manager can then fetch the MetadataFiles in that MetadataFile Version that are smaller than or equal to the Table Version. The DT manager can compute the scanset based on the initial compacted metadata file and the delta metadata.

In some aspects, DT manager 128 can clone containers using the following two phases:
(a) Phase 1. The DT manager creates cloned entities. In some aspects, some of the dependencies associated with the cloned entities may be invalid at the cloning time point.
(b) Phase 2. The DT manager can fix dependencies between the cloned entities.

In some aspects, the DT manager can extend Phase 1 to identify one or more associated versions of the base tables of at least one cloned DT.

In some aspects, the DT manager can extend Phase 2 to replace the MetadataFile Versions of the cloned base tables with the oldest MetadataFile Version that is relevant for DTs and clone the subsequent delta metadata and MetadataFile Version up to the clone time.

In some aspects, the DT manager 128 can configure the execution of a clone operation (e.g., on a schema including a DT and a corresponding base table (BT)), to generate a cloned DT with a corresponding cloned BT. In some aspects, the BT is not included as a part of the cloned container.

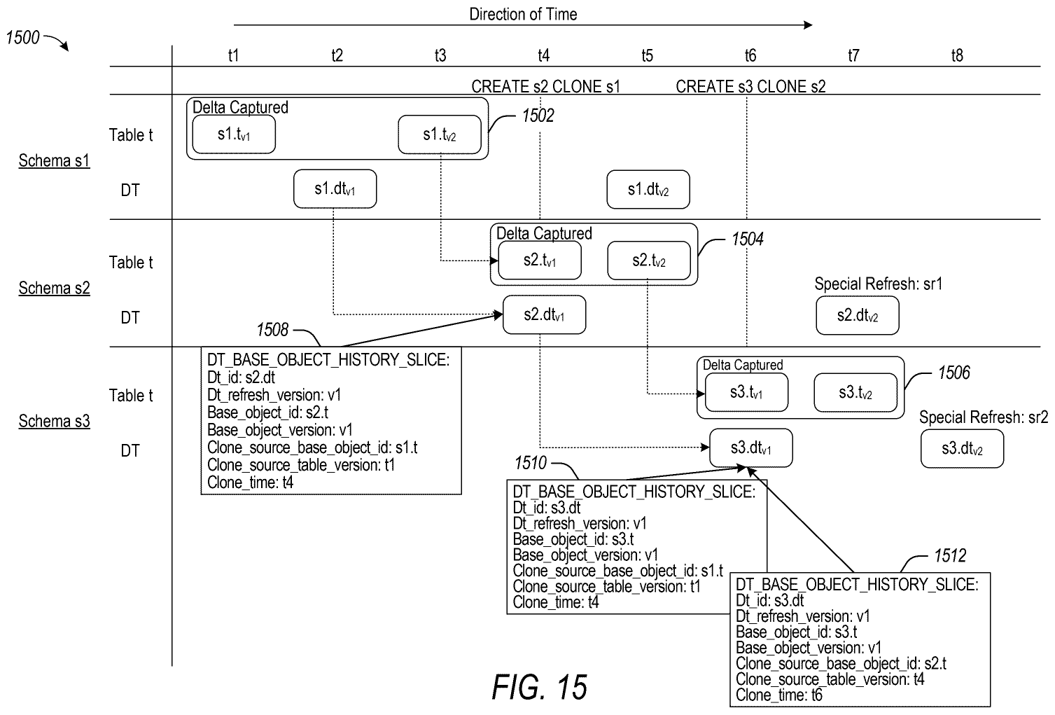

FIG. 15 is a diagram 1500 illustrating the creation of DT clones and corresponding metadata information, in accordance with some embodiments of the present disclosure. For example, schema s1 can include DT s1.dtv1 with corresponding BT table t (with BT versions of table t referenced as s1.tv1 and s1.tv2).

Schema s1 is cloned (e.g., at time t4) to generate schema s2. Schema s2 can include cloned DT s2.dtv1 with corresponding BT table t (e.g., cloned BT versions of table t referenced as s2.tv1 and s2.tv2).

Schema s2 is cloned (e.g., at time t6) to generate schema s3. Schema s3 can include cloned DT s3.dtv1 with corresponding BT table t (e.g., cloned BT versions of table t referenced as s3.tv1 and s3.tv2).

In some aspects, DT manager 128 can configure a refresh operation (also referred to as special refresh or sr) when the DT clone refreshes for the first time to catch up with changes in the BT. In some aspects, DT manager 128 can keep track of the following information in connection with special refresh configuration and scheduling:
(a) The base table of the clone source;
(b) The stream offset on the clone source base table as of the clone time; and
(c) The timestamp of the clone operation.

For example, DT manager 128 can configure the following metadata objects, which can be used in connection with zero-copy DT cloning:

(a) Dynamic TableBaseObject Metadata Object.

To store cloning-related metadata, a new metadata slice (e.g., a collection of different metadata information) can be configured in the DynamicTableBaseObject metadata object:

(a.1) Slice Name: DT_BASE_OBJECT_HISTORY_SLICE

(a.2) Description: For each DT, such metadata object records the base object and its version used by the DT for a given DT version. One DT can have multiple base objects for each DT version. In some aspects, a DT can have multiple DT versions.

(a.3) In some aspects, the following keys can be used for the key-value pairs in the metadata: account ID (Account_id), DT identification (Dt_id), Dt_, domain identification (Domain_id), base object ID (Base_object_id), and clone source table ID (Clone_source_table_id).

(a.4) In some aspects, the following values can be used for the key-value pairs in the metadata: base object version (Base_obj_version), clone time (Clone_time), and clone source table version (Clone_source_table_version).

(b) DynamicTableColumnLineage Metadata Object.

In some aspects, a new slice can be configured in the Dynamic TableColumnLineage metadata object, such as slice DT_BASE_OBJECT_COLUMN_HISTORY_SLICE. In some aspects, this slice can be the same as the DT_BASE_OBJECT_COLUMN metadata slice. In some aspects, such slices can be versioned or unversioned. Additionally, the following keys and values can be used in key-value pairs of the metadata:

(b.1) Keys: account ID (Account_id), DT identification (Dt_id), DT refresh version (Dt_refresh_version), domain identification (Domain_id), base object ID (Base_object_id), and base column ID (Base_column_id).

(b.2) Values: base column name (Base_column_name), external data type (External_data_type), default value (Default_value), and encoded DT column (Encoded_dt_column).

In some aspects, DT manager 128 can use the metadata objects mentioned above to find a given DT table version (e.g., by using range scan, limiting the result to 1 with reverse order, and putting the desired DT table version as the end interval inclusively, such as RangeScan (null, desired_version) reversed order.

In some aspects, DT manager 128 can write both new slices in DynamicTableBaseObject metadata object and DynamicTableColumnLineage metadata object at:
(a) Create time (clone is a form of creation);
(b) Special refresh time; and
(c) Other occasions where query evolution determines a full-reinitialization is required.

In some aspects, the DT manager 128 can delete the relevant metadata objects when the DT falls out of the retention period (e.g., a metadata cleaner can be used to clean the cloning-related metadata objects described above) or when the metadata objects represent a version that is older than the base table's data retention. In some aspects, the DT manager 128 can use the minimum retention time of all the base objects.

Referring to FIG. 15, DT manager 128 can perform a special refresh operation as described herein. In some aspects, DT manager 128 can configure metadata object 1508 with metadata relevant to the cloned DT s2.dtv1 (which indicates the base object ID, base object version, the clone source base object ID, the clone source table version, and the clone time). Similarly, the DT manager can configure metadata objects 1510 and 1512 with metadata relevant to the cloned DT s3.dtv1 (which indicates the base object ID, base object version, the clone source base object ID, the clone source table version, and the clone time).

In some aspects, a CHANGES node can configure a TableScan to produce results in 3 different scenarios: T_{from}, Tₜₒ, and Δ_{t1->tn}(T). In some aspects, all TableScans in the refresh plan can be substituted with the appropriate table and version references as follows:

$${T}_{from} = source\_schema \cdot {t}_{from} ; \qquad ( a )$$

$${T}_{to} = clone\_schema \cdot {t}_{to} ; and \qquad ( b )$$

$${Δ}_{t 1 -> tn} ( sn \cdot t ) = {Δ}_{t 1 -> t 2} ( source\_schema \cdot t ) ⋃ {Δ}_{t 2 -> t 3} ( source\_schema \_ 2 \cdot t ) ⋃ … ⋃ {Δ}_{tn - 1 -> tn} ( source\_schema \_ ( n - 1 ) 2 \cdot t ) . \qquad ( c )$$

In some aspects, DT manager 128 can refresh a cloned DT (e.g., perform sr1 illustrated in FIG. 15) by determining:

$$a delta {Δ}_{t 1 -> t 5} ( s 2 \cdot t ) = {Δ}_{t 1 -> t 3} ( s 2 \cdot t ) ( e . g . , delta 1502 ) ⋃ {Δ}_{t 4 -> t 5} ( s 2 \cdot t ) ( e . g . , delta 1504 ) ; \qquad ( a )$$

$${T}_{from} = s 1 \cdot {t}_{t 1} ; and \qquad ( b )$$

$${T}_{to} = s 2 \cdot {t}_{t 5} . \qquad ( c )$$

In this regard, DT manager 128 can perform sr1 of cloned DT s2.dtv1 based on delta Δ_{t1->t5}(s2.t) (e.g., using delta 1502 representing changes in BT t from time t1 to time t3, and delta 1504 representing changes in cloned base table t in schema s2 from time t4 to time t5).

In some aspects, DT manager 128 can refresh a cloned DT (e.g., perform sr2 illustrated in FIG. 15) by determining:

$$a delta {Δ}_{t 1 -> t 7} ( s 3 \cdot t ) = {Δ}_{t 1 -> t 3} ( s 1 \cdot t ) ( e . g . , delta 1502 ) ⋃ {Δ}_{t 4 -> t 5} ( s 3 \cdot t ) ( e . g . , delta 1504 ) ⋃ {Δ}_{t 6 -> t 7} ( s 3 \cdot t ) ( e . g . , delta 1506 ) ; \qquad ( a )$$

$${T}_{from} = s 1 \cdot {t}_{t 1} ; and \qquad ( b )$$

$${T}_{to} = s 3 \cdot {t}_{t 7} . \qquad ( c )$$

In this regard, DT manager 128 can perform sr2 of cloned DT s3.dtv1 based on delta Δ_{t1->t7}(s3.t) (e.g., using delta 1502 representing changes in BT t from time t1 to time t3, delta 1504 representing changes in cloned base table t in schema s2 from time t4 to time t5, and delta 1506 representing changes in cloned base table t in schema s3 from time t6 to time t7).

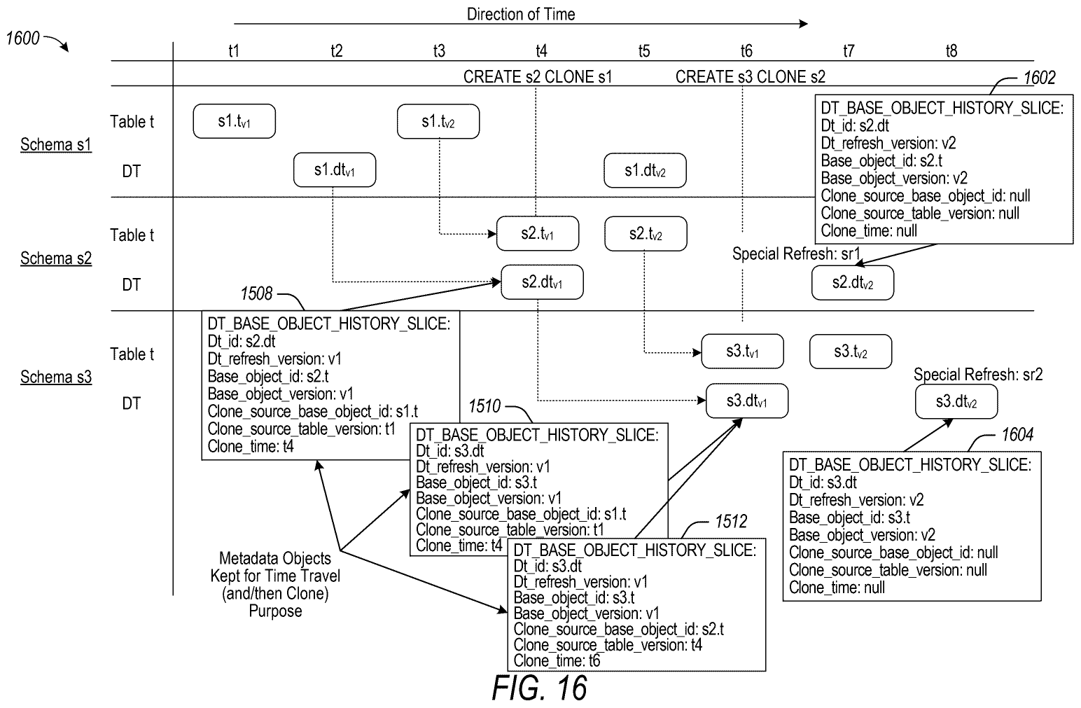

FIG. 16 is a diagram 1600 illustrating the performing of refresh operations on cloned DTs, in accordance with some embodiments of the present disclosure. Referring to FIG. 16, after refresh operations (e.g., sr1 and sr2), the corresponding metadata objects 1602 and 1604 (e.g., DT_BASE_OBJECT_HISTORY_SLICE metadata objects) can be updated to record the DT base object state accordingly.

In some aspects, DT manager 128 can configure time travel and/or cloning of tables using the metadata objects 1508, 1510, 1512, 1602, and 1604. In some aspects, time travel clones (e.g., a DT clone using one of a plurality of prior (time travel) versions of a BT) can be used to enable cloning without the need for reinitialization in some cases. For example, the base object and column lineage history metadata objects can be written when the schema of the DT changes.

In a processing example, T(i num)->DT(select*from T), T's schema is changed, and refreshes are performed based on the following pseudo code listed in Table 6 below:

TABLE 6
Unset
# pseudo code, not actual sql
create table T (i number);
create dynamic table DT as select * from T;
insert into t values(1);
alter dynamic table DT refresh;
alter table T add column j number default 10; insert into T values (2, 21);
alter dynamic table DT refresh;
alter table T drop column i;
insert into T values (99);
alter dynamic table DT refresh;

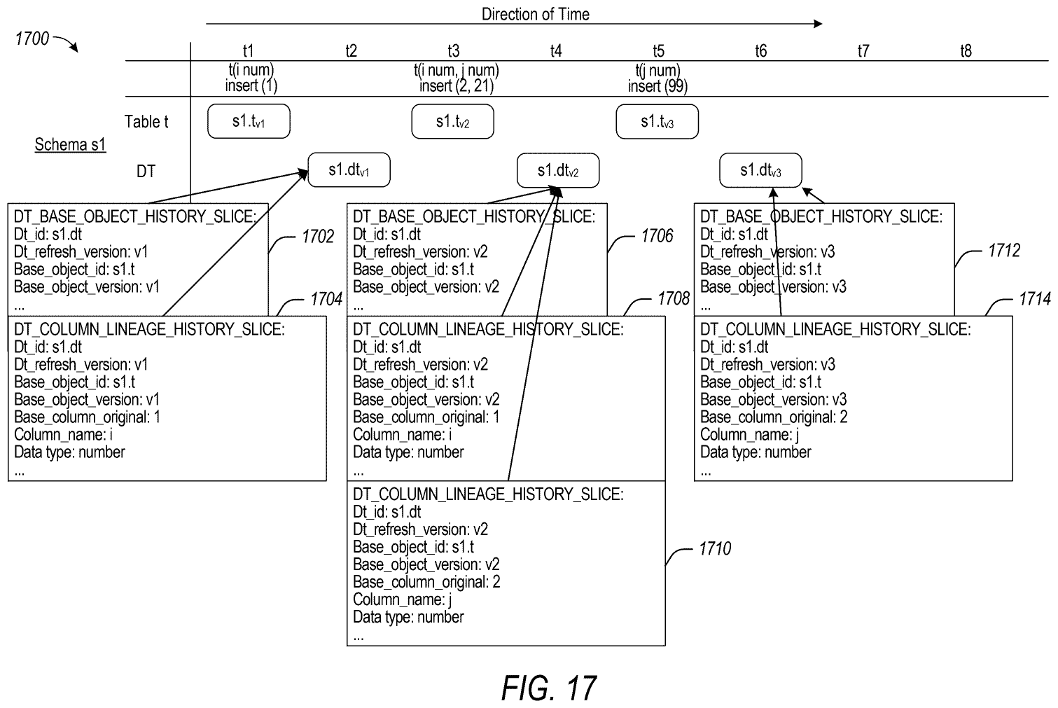

FIG. 17 is a diagram 1700 illustrating the creation of cloned DTs based on different versions of a base table and corresponding metadata information for each clone, in accordance with some embodiments of the present disclosure. Referring to FIG. 17, the DT manager 128 can configure and persist metadata objects for different versions of the DT in schema s1, which can be used for time travel and DT cloning.

For example, the timeline and metadata that the DT manager 128 can persist can include metadata objects 1702 and 1704 (for DT s1.dtv1), metadata objects 1706, 1708, and 1710 (for DT s1.dtv2), and metadata objects 1712 and 1714 (for DT s1.dtv3).

When the DT manager 128 performs time travel back (e.g., time travel back to t2 and clone DT), DT manager 128 can read the table at time t1 and DT and its metadata at time t2 to perform the clone operation.

In some aspects, operations on the source table (e.g., base table) after cloning are incremental. More specifically, operations are incremental because the cloned DT is referencing the source table (or BT) without the modified column. After the modification and not past retention, the corresponding column information and column data still exist. The table version can be read up to the last table version before the clone operation, which will contain the same set of column information as the cloned base table.

In some aspects, DT manager 128 can remove a column from a clone table (e.g., a cloned DT) after the clone is incremental. This operation is incremental since the dropped column can be ignored when creating the new DT version. If the dropped column is used as part of a JOIN operation in the DT without modifying the DT definition, the next refresh will fail.

In some aspects, DT manager 128 can remove a column from the source table before a clone is incremental. In some aspects, a DT can be incrementally refreshed when dropping a used column.

In some aspects, DT manager 128 can add/change the type on a source table (or BT) before a cloned DT may need reinitialization. In some aspects, the existing data in a DT may need to change in the next refresh.

In some aspects, a type associated with a clone table can be added/changed after the clone needs reinitialization. In some aspects, the existing data in a DT may need to change in the next refresh.

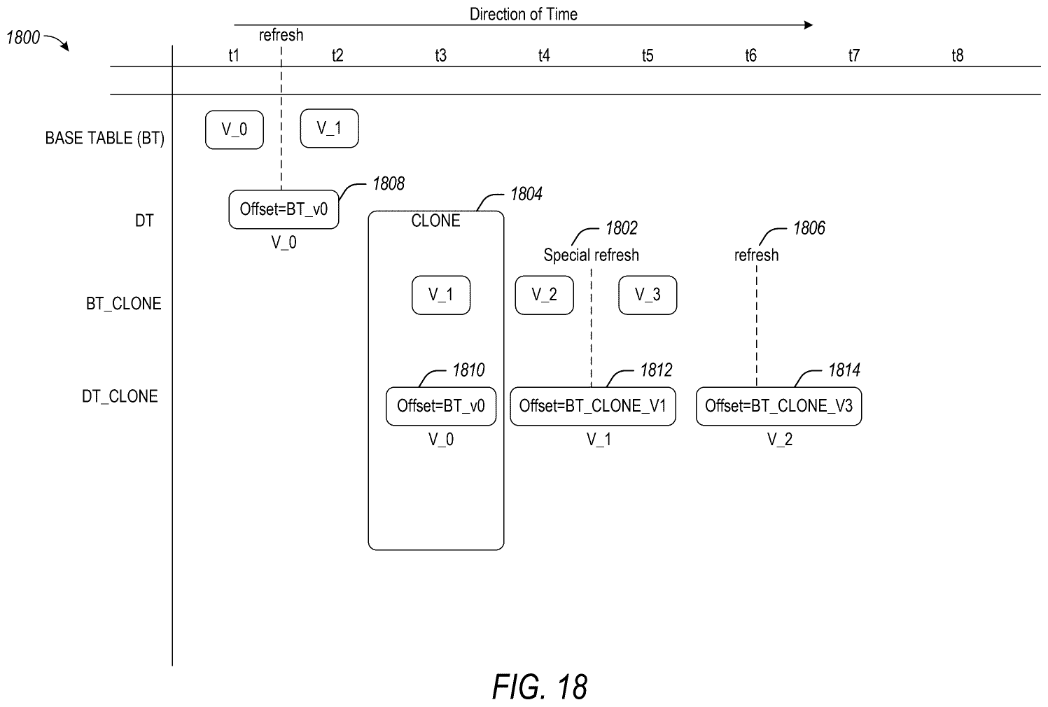

FIG. 18 is a diagram 1800 illustrating the performing of a special refresh operation after cloning, in accordance with some embodiments of the disclosure. Referring to FIG. 18, BT versions V_0 and V_1 are generated at times t1 and t2, respectively. DT 1808 is generated using BT version V_0.

At time t3, a cloning operation 1804 is performed to generate a DT clone 1810 (version V_0) using BT version V_0.

In some aspects, each cloned table can look up its clone source. Hence, a special refresh can be configured that brings the DT up to date as if the DT update was at clone time. After that point, the DT manager 128 can continue with the default refresh behavior.

For example in reference to FIG. 18, the DT manager 128 can perform a special refresh operation 1802 after the cloning operation 1804. More specifically, the BT clone can be updated to generate BT clone version V_2 as the latest version prior to the special refresh operation 1802. During the special refresh operation 1802, a DT clone 1812 (version V_1) is generated using the BT clone version V_1.

After the cloning operation 1804, the BT clone changes with versions V_2 and V_3. A refresh operation 1806 can be performed after the special refresh operation 1802. The refresh operation 1806 results in the generation of DT clone 1814 (version V_2), which is based on BT clone version V_3 (which is the latest version of the BT clone).

In some aspects, the special refresh operation 1802 can be performed using the information about the clone and its source as the first refresh after cloning. For example, the following operations can be performed:
(a) Merge into DT_Clone delta (Base.v_0, Base.v_1); and
(b) Update the offset in DT_Clone.v_1 to point to Base_clone.v_1.

In this regard, even though the special refresh takes place after Base_Clone.v_2, the special refresh operation can refresh DT_Clone to Base_Clone.v_1. In some aspects, the special refresh does not need to adhere to the scheduling algorithm, it can be queued right after the clone, but no other refreshes can be scheduled until it is completed.

In some aspects, an alternative to the above refresh sequence would be to force a refresh of all DTs that are not up to date as step 0 of the cloning operation.

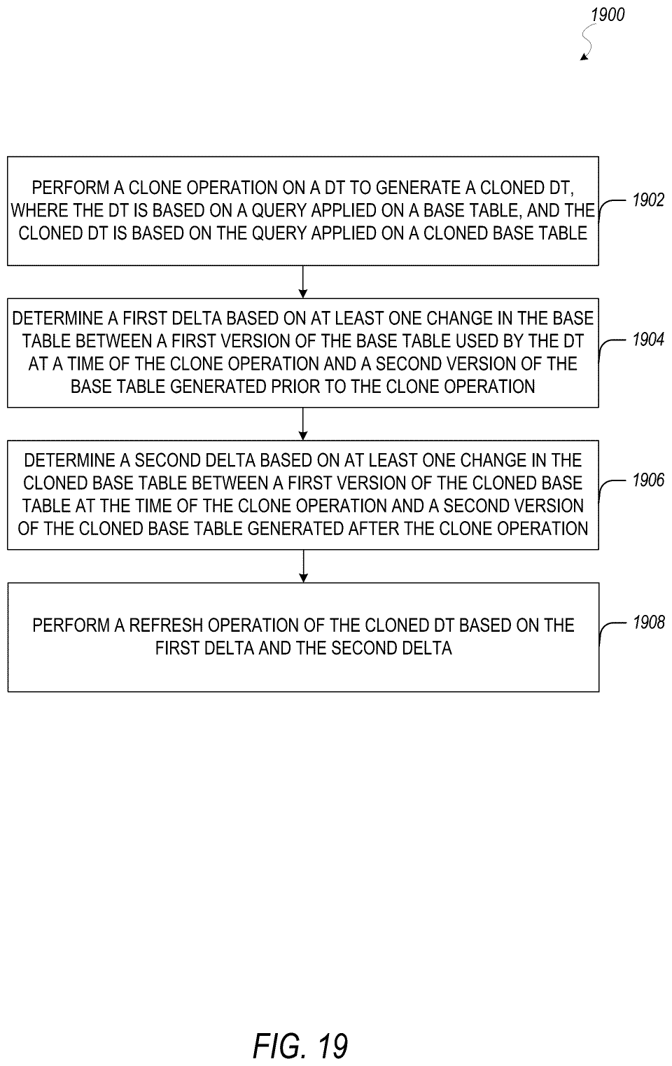

FIG. 19 is a flow diagram illustrating the operations of a database system in performing a method 1900 for cloning a dynamic table, in accordance with some embodiments of the present disclosure. Method 1900 may be embodied in computer-readable instructions for execution by one or more hardware components (e.g., one or more processors) such that the operations of method 1900 may be performed by components of network-based database system 102, such as components of the compute service manager 108 (e.g., the DT manager 128) and/or the execution platform 110 (which components may be implemented as machine 2100 of FIG. 21). Accordingly, method 1900 is described below, by way of example with reference to it. However, it should be noted that method 1900 may be deployed on various other hardware configurations and is not intended to be limited to deployment within the network-based database system 102.

At operation 1902, a clone operation is performed on a dynamic table (DT) to generate a cloned DT. The DT is based on a query applied on a base table. The cloned DT is based on the query applied on a cloned base table corresponding to the base table.

At operation 1904, a first delta is determined based on at least one change in the base table between a first version of the base table used by the DT at the time of the clone operation and a second version of the base table generated prior to the clone operation.

At operation 1906, a second delta is determined based on at least one change in the cloned base table between a first version of the cloned base table at the time of the clone operation and a second version of the cloned base table generated after the clone operation.

At operation 1908, a refresh operation of the cloned DT is performed based on the first delta and the second delta.

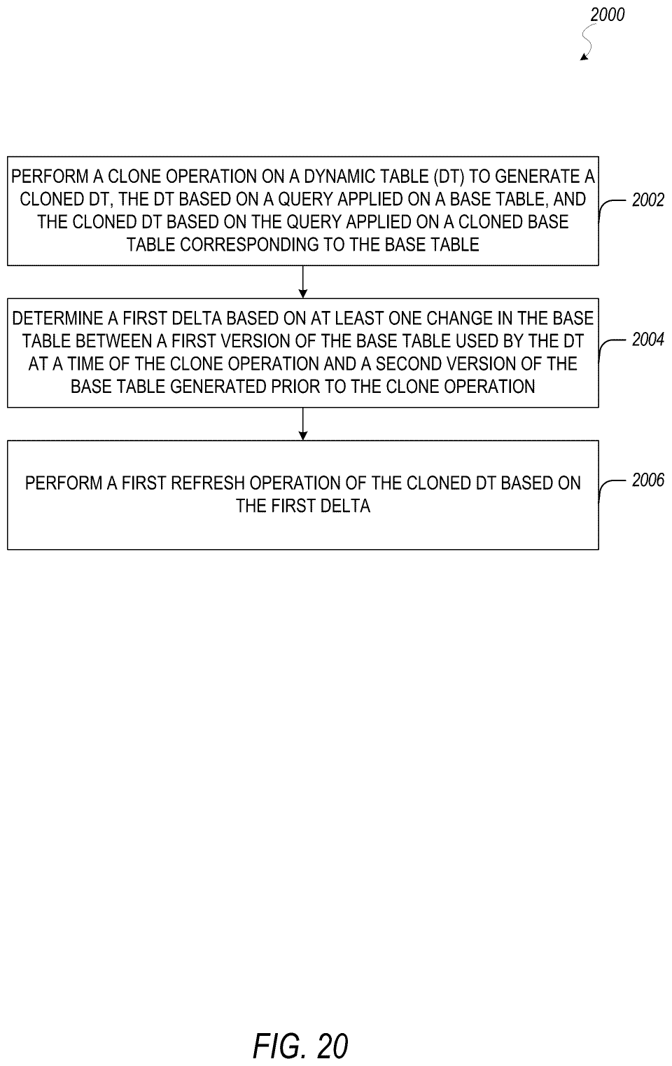

FIG. 20 is a flow diagram illustrating the operations of a database system in performing a method 2000 for cloning a dynamic table, in accordance with some embodiments of the present disclosure. Method 2000 may be embodied in computer-readable instructions for execution by one or more hardware components (e.g., one or more processors) such that the operations of method 2000 may be performed by components of network-based database system 102, such as components of the compute service manager 108 (e.g., the DT manager 128) and/or the execution platform 110 (which components may be implemented as machine 2100 of FIG. 21). Accordingly, method 2000 is described below, by way of example with reference to it. However, it should be noted that method 2000 may be deployed on various other hardware configurations and is not intended to be limited to deployment within the network-based database system 102.

At operation 2002, DT manager 128 performs a clone operation on a DT to generate a cloned DT. The DT is based on a query applied to a base table, and the cloned DT is based on the query applied to a cloned base table corresponding to the base table.

At operation 2004, DT manager 128 determines a first delta (e.g., delta between versions V_0 and V_1 of the BT in FIG. 19) based on at least one change in the base table between a first version of the base table (e.g., version V_0) used by the DT at a time of the clone operation and a second version of the base table (e.g., version V_1) generated prior to the clone operation.

At operation 2006, DT manager 128 performs a first refresh operation (e.g., special refresh operation 1802) of the cloned DT based on the first delta.

FIG. 21 illustrates a diagrammatic representation of a machine 2100 in the form of a computer system within which a set of instructions may be executed to cause the machine 2100 to perform any one or more of the methodologies discussed herein, according to an example embodiment. Specifically, FIG. 21 shows a diagrammatic representation of the machine 2100 in the example form of a computer system, within which instructions 2116 (e.g., software, a program, an application, an applet, an app, or other executable code) for causing the machine 2100 to perform any one or more of the methodologies discussed herein may be executed. For example, instructions 2116 may cause machine 2100 to execute any one or more operations of methods 1900 and 2000 (or any other technique discussed herein, for example, in connection with FIG. 4-FIG. 20). As another example, instructions 2116 may cause machine 2100 to implement one or more portions of the functionalities discussed herein. In this way, instructions 2116 may transform a general, non-programmed machine into a particular machine 2100 (e.g., the compute service manager 108 or a node in the execution platform 110) that is specially configured to carry out any one of the described and illustrated functions in the manner described herein. In yet another embodiment, instructions 2116 may configure the compute service manager 108 and/or a node in the execution platform 110 to carry out any one of the described and illustrated functions in the manner described herein.

In alternative embodiments, the machine 2100 operates as a standalone device or may be coupled (e.g., networked) to other machines. In a networked deployment, machine 2100 may operate in the capacity of a server machine or a client machine in a server-client network environment or as a peer machine in a peer-to-peer (or distributed) network environment. The machine 2100 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 2116, sequentially or otherwise, that specify actions to be taken by the machine 2100. Further, while only a single machine 2100 is illustrated, the term “machine” shall also be taken to include a collection of machines 2100 that individually or jointly execute the instructions 2116 to perform any one or more of the methodologies discussed herein.

Machine 2100 includes processors 2110, memory 2130, and input/output (I/O) components 2150 configured to communicate with each other, such as via bus 2102. In some example embodiments, the processors 2110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 2112 and a processor 2114 that may execute the instructions 2116. The term “processor” is intended to include multi-core processors 2110 that may comprise two or more independent processors (sometimes referred to as “cores”) that may execute instructions 2116 contemporaneously. Although FIG. 21 shows multiple processors 2110, the machine 2100 may include a single processor with a single core, a single processor with multiple cores (e.g., a multi-core processor), multiple processors with a single core, multiple processors with multiple cores, or any combination thereof.

The memory 2130 may include a main memory 2132, a static memory 2134, and a storage unit 2136, all accessible to the processors 2110, such as via the bus 2102. The main memory 2132, the static memory 2134, and the storage unit 2136 store the instructions 2116 embodying any one or more of the methodologies or functions described herein. The instructions 2116 may also reside, completely or partially, within the main memory 2132, within the static memory 2134, within machine storage medium 2138 of the storage unit 2136, within at least one of the processors 2110 (e.g., within the processor's cache memory), or any suitable combination thereof, during execution thereof by the machine 2100.

The I/O components 2150 include components to receive input, provide output, produce output, transmit information, exchange information, capture measurements, and so on. The specific I/O components 2150 that are included in a particular machine 2100 will depend on the type of machine. For example, portable machines such as mobile phones will likely include a touch input device or other such input mechanisms. In contrast, a headless server machine will likely not include such a touch input device. It will be appreciated that the I/O components 2150 may include many other components that are not shown in FIG. 21. The I/O components 2150 are grouped according to functionality merely to simplify the following discussion, and the grouping is in no way limiting. In various example embodiments, the I/O components 2150 may include output components 2152 and input components 2154. The output components 2152 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 2154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 2150 may include communication components 2164, operable to couple the machine 2100 to a network 2180 or devices 2170 via a coupling 2182 and a coupling 2172, respectively. For example, communication components 2164 may include a network interface component or another suitable device to interface with network 2180. In further examples, communication components 2164 may include wired communication components, wireless communication components, cellular communication components, and other communication components to provide communication via other modalities. The device 2170 may be another machine or any of a wide variety of peripheral devices (e.g., a peripheral device coupled via a universal serial bus (USB)). For example, as noted above, machine 2100 may correspond to any one of the compute service manager 108 or the execution platform 110, and device 2170 may include the client device 114 or any other computing device described herein as being in communication with the network-based database system 102 or the cloud storage platform 104.

The various memories (e.g., 2130, 2132, 2134, and/or memory of the processor(s) 2110 and/or the storage unit 2136) may store one or more sets of instructions 2116 and data structures (e.g., software) embodying or utilized by any one or more of the methodologies or functions described herein. These instructions 2116, when executed by the processor(s) 2110, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database and/or associated caches and servers) that store executable instructions and/or data. The terms shall accordingly be taken to include, but not be limited to, solid-state memories and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 2180 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 2180 or a portion of network 2180 may include a wireless or cellular network, and the coupling 2182 may be a Code Division Multiple Access (CDMA) connection, a Global System for Mobile communications (GSM) connection, or another cellular or wireless coupling. In this example, the coupling 2182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 2116 may be transmitted or received over network 2180 using a transmission medium via a network interface device (e.g., a network interface component included in the communication components 2164) and utilizing any one of several well-known transfer protocols (e.g., hypertext transfer protocol (HTTP)). Similarly, instructions 2116 may be transmitted or received using a transmission medium via coupling 2172 (e.g., a peer-to-peer coupling) to device 2170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2116 for execution by the machine 2100 and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments, the processors may be distributed across several locations.

Described implementations of the subject matter can include one or more features, alone or in combination, as illustrated below by way of examples.

Example 1 is a system comprising at least one hardware processor; and at least one memory storing instructions that cause the at least one hardware processor to perform operations comprising: performing a clone operation on a dynamic table (DT) to generate a cloned DT, the DT based on a query applied on a base table, and the cloned DT based on the query applied on a cloned base table corresponding to the base table; determining a first delta based on at least one change in the base table between a first version of the base table used by the DT at a time of the clone operation and a second version of the base table generated prior to the clone operation; and performing a first refresh operation of the cloned DT based on the first delta.

In Example 2, the subject matter of Example 1 includes subject matter such as generating the cloned DT and the cloned base table during the performing of the clone operation.

In Example 3, the subject matter of Example 2 includes subject matter such as updating, prior to the first refresh operation, an offset associated with the cloned DT to point to the first version of the base table.

In Example 4, the subject matter of Examples 1-3 includes subject matter such as performing the first refresh operation to generate a second cloned DT based on the cloned DT.

In Example 5, the subject matter of Example 4 includes subject matter such as merging the first delta into the second cloned DT.

In Example 6, the subject matter of Example 5 includes subject matter such as updating an offset associated with the second cloned DT to point to a first version of the cloned base table corresponding to the second version of the base table.

In Example 7, the subject matter of Example 6 includes subject matter such as determining a second delta based on at least one change in the cloned base table between the first version of the cloned base table at the time of the clone operation and a second version of the cloned base table generated after the first refresh operation.

In Example 8, the subject matter of Example 7 includes subject matter such as performing a second refresh operation of the second cloned DT to generate a third cloned DT.

In Example 9, the subject matter of Example 8 includes subject matter such as merging the second delta into the third cloned DT.

In Example 10, the subject matter of Example 9 includes subject matter such as updating an offset associated with the third cloned DT to point to the second version of the cloned base table.

Example 11 is a method comprising: performing, by at least one hardware processor, a clone operation on a dynamic table (DT) to generate a cloned DT, the DT based on a query applied on a base table, and the cloned DT based on the query applied on a cloned base table corresponding to the base table; determining a first delta based on at least one change in the base table between a first version of the base table used by the DT at a time of the clone operation and a second version of the base table generated prior to the clone operation; and performing a first refresh operation of the cloned DT based on the first delta.

In Example 12, the subject matter of Example 11 includes generating the cloned DT and the cloned base table during the clone operation.

In Example 13, the subject matter of Example 12 includes updating prior to the first refresh operation, an offset associated with the cloned DT to point to the first version of the base table.

In Example 14, the subject matter of Examples 11-13 includes performing the first refresh operation to generate a second cloned DT based on the cloned DT.

In Example 15, the subject matter of Example 14 includes merging the first delta into the second cloned DT.

In Example 16, the subject matter of Example 15 includes updating an offset associated with the second cloned DT to point to a first version of the cloned base table corresponding to the second version of the base table.

In Example 17, the subject matter of Example 16 includes determining a second delta based on at least one change in the cloned base table between the first version of the cloned base table at the time of the clone operation and a second version of the cloned base table generated after the first refresh operation.

In Example 18, the subject matter of Example 17 includes performing a second refresh operation of the second cloned DT to generate a third cloned DT.

In Example 19, the subject matter of Example 18 includes merging the second delta into the third cloned DT.

In Example 20, the subject matter of Example 19 includes updating an offset associated with the third cloned DT to point to the second version of the cloned base table.

Example 21 is a computer-storage medium comprising instructions that, when executed by one or more processors of a machine, configure the machine to perform operations comprising: performing, by at least one hardware processor, a clone operation on a dynamic table (DT) to generate a cloned DT, the DT based on a query applied on a base table, and the cloned DT based on the query applied on a cloned base table corresponding to the base table; determining a first delta based on at least one change in the base table between a first version of the base table used by the DT at a time of the clone operation and a second version of the base table generated prior to the clone operation; and performing a first refresh operation of the cloned DT based on the first delta.

In Example 22, the subject matter of Example 21 includes subject matter such as generating the cloned DT and the cloned base table during the performing of the clone operation.

In Example 23, the subject matter of Example 22 includes subject matter such as updating prior to the first refresh operation, an offset associated with the cloned DT to point to the first version of the base table.

In Example 24, the subject matter of Examples 21-23 includes subject matter such as performing the first refresh operation to generate a second cloned DT based on the cloned DT.

In Example 25, the subject matter of Example 24 includes subject matter such as merging the first delta into the second cloned DT.

In Example 26, the subject matter of Example 25 includes subject matter such as updating an offset associated with the second cloned DT to point to a first version of the cloned base table corresponding to the second version of the base table.

In Example 27, the subject matter of Example 26 includes subject matter such as determining a second delta based on at least one change in the cloned base table between the first version of the cloned base table at the time of the clone operation and a second version of the cloned base table generated after the first refresh operation.

In Example 28, the subject matter of Example 27 includes subject matter such as performing a second refresh operation of the second cloned DT to generate a third cloned DT.

In Example 29, the subject matter of Example 28 includes subject matter such as merging the second delta into the third cloned DT.

In Example 30, the subject matter of Example 29 includes subject matter such as updating an offset associated with the third cloned DT to point to the second version of the cloned base table.

Example 31 is at least one machine-readable medium including instructions that, when executed by processing circuitry, cause the processing circuitry to perform operations to implement of any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not specifically described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
performing a clone operation on a dynamic table (DT) to generate a cloned DT, the DT based on a query applied on a base table, and the cloned DT based on the query applied on a cloned base table corresponding to the base table;
determining a first delta based on at least one change in the base table between a first version of the base table used by the DT at a time of the clone operation and a second version of the base table generated prior to the clone operation; and
performing a first refresh operation of the cloned DT based on the first delta.

2. The system of claim 1, the operations comprising:
generating the cloned DT and the cloned base table during the performing of the clone operation.

3. The system of claim 2, the operations comprising:
updating prior to the first refresh operation, an offset associated with the cloned DT to point to the first version of the base table.

4. The system of claim 1, the operations comprising:
performing the first refresh operation to generate a second cloned DT based on the cloned DT.

5. The system of claim 4, the operations comprising:
merging the first delta into the second cloned DT.

6. The system of claim 5, the operations comprising:
updating an offset associated with the second cloned DT to point to a first version of the cloned base table corresponding to the second version of the base table.

7. The system of claim 6, the operations comprising:
determining a second delta based on at least one change in the cloned base table between the first version of the cloned base table at the time of the clone operation and a second version of the cloned base table generated after the first refresh operation;
performing a second refresh operation of the second cloned DT to generate a third cloned DT;
merging the second delta into the third cloned DT; and
updating an offset associated with the third cloned DT to point to the second version of the cloned base table.

8. A method comprising:
performing, by at least one hardware processor, a clone operation on a dynamic table (DT) to generate a cloned DT, the DT based on a query applied on a base table, and the cloned DT based on the query applied on a cloned base table corresponding to the base table;
determining a first delta based on at least one change in the base table between a first version of the base table used by the DT at a time of the clone operation and a second version of the base table generated prior to the clone operation; and
performing a first refresh operation of the cloned DT based on the first delta.

9. The method of claim 8, further comprising:
generating the cloned DT and the cloned base table during the performing of the clone operation.

10. The method of claim 9, further comprising:
updating prior to the first refresh operation, an offset associated with the cloned DT to point to the first version of the base table.

11. The method of claim 8, further comprising:
performing the first refresh operation to generate a second cloned DT based on the cloned DT.

12. The method of claim 11, further comprising:
merging the first delta into the second cloned DT.

13. The method of claim 12, further comprising:
updating an offset associated with the second cloned DT to point to a first version of the cloned base table corresponding to the second version of the base table.

14. The method of claim 13, further comprising:
determining a second delta based on at least one change in the cloned base table between the first version of the cloned base table at the time of the clone operation and a second version of the cloned base table generated after the first refresh operation;
performing a second refresh operation of the second cloned DT to generate a third cloned DT;
merging the second delta into the third cloned DT; and
updating an offset associated with the third cloned DT to point to the second version of the cloned base table.

15. A computer-storage medium comprising instructions that, when executed by one or more processors of a machine, configure the machine to perform operations comprising:
performing, by at least one hardware processor, a clone operation on a dynamic table (DT) to generate a cloned DT, the DT based on a query applied on a base table, and the cloned DT based on the query applied on a cloned base table corresponding to the base table;
determining a first delta based on at least one change in the base table between a first version of the base table used by the DT at a time of the clone operation and a second version of the base table generated prior to the clone operation; and
performing a first refresh operation of the cloned DT based on the first delta.

16. The computer-storage medium of claim 15, the operations comprising:
generating the cloned DT and the cloned base table during the performing of the clone operation.

17. The computer-storage medium of claim 16, the operations comprising:
updating prior to the first refresh operation, an offset associated with the cloned DT to point to the first version of the base table.

18. The computer-storage medium of claim 15, the operations comprising:
performing the first refresh operation to generate a second cloned DT based on the cloned DT.

19. The computer-storage medium of claim 18, the operations comprising:
merging the first delta into the second cloned DT.

20. The computer-storage medium of claim 19, the operations comprising:
updating an offset associated with the second cloned DT to point to a first version of the cloned base table corresponding to the second version of the base table;
determining a second delta based on at least one change in the cloned base table between the first version of the cloned base table at the time of the clone operation and a second version of the cloned base table generated after the first refresh operation;
performing a second refresh operation of the second cloned DT to generate a third cloned DT;
merging the second delta into the third cloned DT; and
updating an offset associated with the third cloned DT to point to the second version of the cloned base table.
